(19) United States
(12) Patent Application Publication
(10) Pub. No.: US 2026/0323536 A1
(43) Pub. Date: Oct. 15, 2026

(54) Method and Apparatus for Power Headroom Reporting

(71) Applicant: TELEFONAKTIEBOLAGET LM ERICSSON (PUBL), Stockholm (SE)

(72) Inventors: Ling Su, Beijing (CN); Chunhui Zhang, Stockholm (SE); Robert Mark Harrison, Grapevine, TX (US)

(21) Appl. No.: 19/483,732

(22) PCT Filed: Jun. 18, 2024
(86) PCT No.: PCT/SE2024/050595

§ 371 Date: Nov. 12, 2025

(30) Foreign Application Priority Data
Jul. 14, 2023 (WO) PCT/CN2023/107559

(51) Int. Cl. H04W 52/36

(52) U.S. Cl. CPC H04W 52/365

(57) ABSTRACT

Embodiments of the present disclosure provide method and apparatus for power headroom reporting. A method performed by a terminal device may comprise sending a first power headroom report (PHR) to a network device. The first PHR comprises first power headroom information for a first waveform and second power headroom information for a second waveform. The second power headroom information for the second waveform comprises information about maximum output power of the second waveform configured for the terminal device.

This is a PCT application claiming the priority for PCT application PCT/CN2023/107559, filed on Jul. 14, 2023.

### TECHNICAL FIELD

The non-limiting and exemplary embodiments of the present disclosure generally relate to the technical field of communications, and specifically to methods and apparatuses for power headroom reporting.

### BACKGROUND

This section introduces aspects that may facilitate a better understanding of the disclosure. Accordingly, the statements of this section are to be read in this light and are not to be understood as admissions about what is in the prior art or what is not in the prior art.

In various wireless communication networks such as Long-Term Evolution (LTE) or new radio (NR), there are various power headroom reporting mechanisms. The power headroom reporting mechanisms may be used by a terminal device such as User Equipment (UE) to report its power headroom information such as available transmit power and/or terminal device configured maximum output power and/or power headroom, etc. to a network device such as base station.

The power headroom reporting mechanisms may allow the network device to effectively manage various resources and/or allocate appropriate power levels to the terminal device and/or determine waveform switching. By knowing the power headroom information of the terminal device, the network device can make informed decisions regarding resource allocation and/or power control and/or waveform switching, ensuring efficient and/or reliable communication.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In NR up to Third Generation Partnership Project (3GPP) release 17, the power headroom report (PHR) of a current Physical Uplink Shared Channel (PUSCH) waveform can be triggered periodically, for example when a PHR Periodic Timer (e.g., phr-PeriodicTimer as defined in 3GPP TS 38.321 V17.5.0, the disclosure of which is incorporated by reference herein in its entirety) expires, and by some events, for example when the path loss has changed more than PHT transmission Power Factor Change dB (e.g., phr-Tx-PowerFactorChange as defined in 3GPP TS 38.321 V17.0.) since the last transmission of a PHR in this medium access control (MAC) entity. There are multiple PHR MAC control element (CE) formats for single carrier, uplink (UL) Carrier Aggregation (CA), and multiple transmission point (mTRP), with fixed or variable sizes. Nevertheless, Type 1 power headroom reported in the legacy PHR MAC CE is always based on the currently configured PUSCH waveform.

Power headroom report of a target waveform was agreed as a potential enhancement to assist network device determination of dynamic waveform switching in 3GPP release 18. The agreement in 3GPP RAN #100 “RAN2 will not work on PHR triggering procedure for dynamic waveform switching in release 18 UL Coverage enh WI” implies that the legacy PHR triggering events are to be reused for the enhanced PHR. In other words, when a legacy PHR triggering event occurs, the power headroom report of both the current waveform and the target waveform is triggered. However, there is no disclosed design of a PHR MAC CE including power headroom information of two waveforms.

To overcome or mitigate at least one of above mentioned problems or other problems, the embodiments of the present disclosure propose an improved solution for power headroom reporting.

In a first aspect of the disclosure, there is provided a method performed by a terminal device. The method may comprise sending a first power headroom report (PHR) to a network device.

In an embodiment, the first PHR may comprise first power headroom information for a first waveform and/or second power headroom information for a second waveform.

In an embodiment, the first power headroom information for the first waveform may comprise information about first terminal device configured maximum output power and/or information about first power headroom.

In an embodiment, the second power headroom information for the second waveform may comprise information about second terminal device configured maximum output power and/or information about second power headroom.

In an embodiment, the first PHR may comprise the information about the first terminal device configured maximum output power, the information about the second terminal device configured maximum output power and one of the information about the first power headroom and the information about the second power headroom.

In an embodiment, the first PHR may comprise the information about the first power headroom, the information about the second power headroom and one of the information about the first terminal device configured maximum output power and the information about the second terminal device configured maximum output power.

In an embodiment, the first PHR may comprise first waveform indication information associated with the information about the first power headroom information and/or second waveform indication information associated with the information about the second power headroom information.

In an embodiment, the first waveform indication information and/or the second waveform indication information may be indicated by at least one of a bit of a new field in a PHR medium access control (MAC) control element (CE), a bit of an existing field in a PHR MAC CE, or a predefined rule.

In an embodiment, the predefined rule may comprise at least one of the second power headroom information may be appended after the first power headroom information, the information about second terminal device configured maximum output power for the second waveform may be appended after the information about the first terminal device configured maximum output power, or the information about the second power headroom for the second waveform may be appended after the information about the first power headroom for the first waveform.

In an embodiment, the existing field in the PHR MAC CE may comprise a reserved field.

In an embodiment, the information about the second terminal device configured maximum output power or the information about the second power headroom for the second waveform may be appended after an existing PHR MAC CE format for multiple transmission reception point. The existing PHR MAC CE format may comprise the first terminal device configured maximum output power and the first power headroom for the first waveform.

In an embodiment, the information about the first terminal device configured maximum output power for the first waveform may comprise information indicating the first terminal device configured maximum output power, or information indicating a first difference of the first terminal device configured maximum output power and a first power value and the information about the second terminal device configured maximum output power for the second waveform may comprise information indicating the second terminal device configured maximum output power, or information indicating a second difference of the first terminal device configured maximum output power and the second terminal device configured maximum output power, or information indicating a third difference of the second terminal device configured maximum output power and the first power value.

In an embodiment, the information about the first power headroom for the first waveform may comprise information indicating the first power headroom, or information indicating a fourth difference of the first power headroom and a second power value and the information about the second power headroom for the second waveform may comprise information indicating the second power headroom, or information indicating a fifth difference of the first power headroom and the second power headroom, or information indicating a sixth difference of the second power headroom and the second power value.

In an embodiment, the first power value and/or the second power value may comprise at least one of a nominal power of a power class of the terminal device, a configured value, or a predetermined value.

In an embodiment, the first PHR may comprise power headroom information of a waveform selected from the first waveform and the second waveform.

In an embodiment, the method may further comprise sending a second PHR to the network device. The second PHR may comprise power headroom information for a remaining waveform from the first waveform and the second waveform.

In an embodiment, if the terminal device receives Downlink Control Information (DCI) indicating waveform switching after a transmission of the first PHR and before a transmission of the second PHR, the transmission of the second PHR is canceled.

In an embodiment, the method may further receiving a signaling indicating a waveform switching from the network device.

In an embodiment, a waveform selection is based on at least one of the second waveform is selected if the most recent transmission used the first waveform; the first waveform is selected if the most recent transmission used the second waveform; a target waveform is selected; when a current waveform is CP-OFDM, if a power headroom of the current waveform is negative, the target waveform is selected; when the current waveform is CP-OFDM, if the power headroom of the current waveform is positive, the current waveform is selected; when a current waveform is Discrete Fourier Transform spread OFDM (DFT-S-OFDM), if a power headroom of the current waveform is positive, the target waveform is selected; if a power headroom of a most recent transmission is negative, DFT-S-OFDM is selected, otherwise CP-OFDM is selected; or when the current waveform is DFT-S-OFDM, if the power headroom of the current waveform is negative, the current waveform is selected.

In an embodiment, the method may further comprise starting or restarting a PHR periodic timer and/or a PHR prohibit timer based on at least one of upon receiving a Radio Resource Control (RRC) or DCI signaling indicating a waveform switching from the network node, upon a start or end of a first Physical Uplink Shared Channel (PUSCH) transmission with a new switched waveform, or upon RRC configuration or reconfiguration of dynamic waveform switching.

In an embodiment, a first part of an octet in a first PHR MAC CE may indicate the power headroom for the second waveform and a second part of the octet indicates the power headroom for the first waveform.

In an embodiment, a third part of an octet in the first PHR MAC CE may indicate the terminal device configured maximum output power for the second waveform and a fourth part of the octet in the first PHR MAC CE may indicate the terminal device configured maximum output power for the first waveform.

In an embodiment, the first PHR MAC CE may comprise a Single Entry PHR MAC CE.

In an embodiment, the first part of the octet may comprise three bits.

In an embodiment, the fourth part of the octet may comprise three bits.

In an embodiment, the third and fourth parts of the octet may indicate a first and a second power difference, Pₘₐₓ₁−P and Pₘₐₓ₂−P, respectively. Pₘₐₓ₁ is the terminal device configured maximum output power for the first waveform. Pₘₐₓ₂ is the terminal device configured maximum output power for the second waveform. P is a predetermined power value that is at least one of a power corresponding to a power class of the terminal device, and a power level configured to the terminal device for the purpose of determining the first PHR.

In an embodiment, the method may further comprise comparing the first power difference Pₘₐₓ₁−P to a series of lower and upper values, thereby producing a first quantized value carried in the third part of the octet. The method may further comprise comparing the second power difference Pₘₐₓ₂−P to the series of lower and upper values, thereby producing a second quantized value carried in the fourth part of the octet.

In an embodiment, a number of existing power headroom values may be reduced based on a length of the first part and/or a length the second part.

In an embodiment, a number of existing terminal device configured maximum output power values may be reduced based on a length of the third part and/or a length the fourth part.

In an embodiment, one of every several consecutive existing power headroom values is selected.

In an embodiment, one of every several consecutive existing terminal device configured maximum output power values is selected.

In an embodiment, every several consecutive existing power headroom values are combined.

In an embodiment, every several consecutive existing terminal device configured maximum output power values are combined.

In an embodiment, which one from each of several consecutive existing power headroom values is selected is predetermined.

In an embodiment, which one from each of several consecutive existing terminal device configured maximum output power values is selected is predetermined.

In an embodiment, if an actual PUSCH is multi-layer PUSCH with CP-OFDM, a capability of the terminal device reporting power headroom information of a target waveform may be indicated by at least one of reporting power headroom information of the target waveform for multi-layer PUSCH and for single-layer PUSCH are separate terminal device capabilities, a capability of PHR of the target waveform is release independent. If the terminal device indicates such capability and it supports multi-layer PUSCH with DFT-S-OFDM, the terminal device can support PHR of target waveform transmitted in a multi-layer PUSCH.

In an embodiment, the first waveform is CP-OFDM and the second waveform is DFT-S-OFDM.

In an embodiment, the first waveform is DFT-S-OFDM and the second waveform is CP-OFDM.

In an embodiment, the first waveform is a current waveform and the second waveform is a target waveform.

In an embodiment, the first waveform is a target waveform and the second waveform is a current waveform.

In a second aspect of the disclosure, there is provided a method performed by a network device. The method may comprise receiving a first power headroom report (PHR) from a terminal device.

In an embodiment, the first PHR may comprise first power headroom information for a first waveform and/or second power headroom information for a second waveform.

In an embodiment, the first power headroom information for the first waveform may comprise information about first terminal device configured maximum output power and/or information about first power headroom.

In an embodiment, the second power headroom information for the second waveform may comprise information about second terminal device configured maximum output power and/or information about second power headroom.

In an embodiment, the first PHR may comprise the information about the first terminal device configured maximum output power, the information about the second terminal device configured maximum output power and one of the information about the first power headroom and the information about the second power headroom.

In an embodiment, the first PHR may comprise the information about the first power headroom, the information about the second power headroom and one of the information about the first terminal device configured maximum output power and the information about the second terminal device configured maximum output power.

In an embodiment, the first PHR may comprise first waveform indication information associated with the information about the first power headroom information and/or second waveform indication information associated with the information about the second power headroom information.

In an embodiment, the first waveform indication information and/or the second waveform indication information may be indicated by at least one of a bit of a new field in a PHR medium access control (MAC) control element (CE), a bit of an existing field in a PHR MAC CE, or a predefined rule.

In an embodiment, the predefined rule may comprise at least one of the second power headroom information may be appended after the first power headroom information, the information about second terminal device configured maximum output power for the second waveform may be appended after the information about the first terminal device configured maximum output power, or the information about the second power headroom for the second waveform may be appended after the information about the first power headroom for the first waveform.

In an embodiment, the existing field in the PHR MAC CE may comprise a reserved field.

In an embodiment, the information about the second terminal device configured maximum output power or the information about the second power headroom for the second waveform may be appended after an existing PHR MAC CE format for multiple transmission reception point. The existing PHR MAC CE format may comprise the first terminal device configured maximum output power and the first power headroom for the first waveform.

In an embodiment, the information about the first terminal device configured maximum output power for the first waveform may comprise information indicating the first terminal device configured maximum output power, or information indicating a first difference of the first terminal device configured maximum output power and a first power value and the information about the second terminal device configured maximum output power for the second waveform may comprise information indicating the second terminal device configured maximum output power, or information indicating a second difference of the first terminal device configured maximum output power and the second terminal device configured maximum output power, or information indicating a third difference of the second terminal device configured maximum output power and the first power value.

In an embodiment, the information about the first power headroom for the first waveform may comprise information indicating the first power headroom, or information indicating a fourth difference of the first power headroom and a second power value and the information about the second power headroom for the second waveform may comprise information indicating the second power headroom, or information indicating a fifth difference of the first power headroom and the second power headroom, or information indicating a sixth difference of the second power headroom and the second power value.

In an embodiment, the first power value and/or the second power value may comprise at least one of a nominal power of a power class of the terminal device, a configured value, or a predetermined value.

In an embodiment, the first PHR may comprise power headroom information of a waveform selected from the first waveform and the second waveform.

In an embodiment, the method may further receiving a second PHR from the terminal device. The second PHR may comprise power headroom information for a remaining waveform from the first waveform and the second waveform.

In an embodiment, the method may further determining a waveform switching based on the first PHR and/or the second PHR. The method may further sending a signaling indicating a waveform switching to the terminal device.

In an embodiment, a first part of an octet in a first PHR MAC CE may indicate the power headroom for the second waveform and a second part of the octet indicates the power headroom for the first waveform.

In an embodiment, a third part of an octet in the first PHR MAC CE may indicate the terminal device configured maximum output power for the second waveform and a fourth part of the octet in the first PHR MAC CE may indicate the terminal device configured maximum output power for the first waveform.

In an embodiment, the first PHR MAC CE may comprise a Single Entry PHR MAC CE.

In an embodiment, the first part of the octet may comprise three bits.

In an embodiment, the fourth part of the octet may comprise three bits.

In an embodiment, the third and fourth parts of the octet may indicate a first and a second power difference, Pₘₐₓ₁−P and Pₘₐₓ₂−P, respectively. Pₘₐₓ₁ is the terminal device configured maximum output power for the first waveform. Pₘₐₓ₂ is the terminal device configured maximum output power for the second waveform. P is a predetermined power value that is at least one of a power corresponding to a power class of the terminal device, and a power level configured to the terminal device for the purpose of determining the first PHR.

In an embodiment, the first power difference Pₘₐₓ₁−P to a series of lower and upper values is compared to produce a first quantized value carried in the third part of the octet.

In an embodiment, the second power difference Pₘₐₓ₂−P to the series of lower and upper values is compared to produce a second quantized value carried in the fourth part of the octet.

In an embodiment, a number of existing power headroom values may be reduced based on a length of the first part and/or a length the second part.

In an embodiment, a number of existing terminal device configured maximum output power values may be reduced based on a length of the third part and/or a length the fourth part.

In an embodiment, one of every several consecutive existing power headroom values is selected.

In an embodiment, one of every several consecutive existing terminal device configured maximum output power values is selected.

In an embodiment, every several consecutive existing power headroom values are combined.

In an embodiment, every several consecutive existing terminal device configured maximum output power values are combined.

In an embodiment, which one from each of several consecutive existing power headroom values is selected is predetermined.

In an embodiment, which one from each of several consecutive existing terminal device configured maximum output power values is selected is predetermined.

In an embodiment, if an actual PUSCH is multi-layer PUSCH with CP-OFDM, a capability of the terminal device reporting power headroom information of a target waveform may be indicated by at least one of reporting power headroom information of the target waveform for multi-layer PUSCH and for single-layer PUSCH are separate terminal device capabilities, a capability of PHR of the target waveform is release independent. If the terminal device indicates such capability and it supports multi-layer PUSCH with DFT-S-OFDM, the terminal device can support PHR of target waveform transmitted in a multi-layer PUSCH.

In an embodiment, the first waveform is CP-OFDM and the second waveform is DFT-S-OFDM.

In an embodiment, the first waveform is DFT-S-OFDM and the second waveform is CP-OFDM.

In an embodiment, the first waveform is a current waveform and the second waveform is a target waveform.

In an embodiment, the first waveform is a target waveform and the second waveform is a current waveform.

In a third aspect of the disclosure, there is provided a terminal device. The terminal device may comprise a processor and a memory coupled to the processor. Said memory contains instructions executable by said processor. Said terminal device is operative to send a first power headroom report (PHR) to a network device.

In an embodiment, the first PHR may comprise first power headroom information for a first waveform and/or second power headroom information for a second waveform.

In an embodiment, the first power headroom information for the first waveform may comprise information about first terminal device configured maximum output power and/or information about first power headroom.

In an embodiment, the second power headroom information for the second waveform may comprise information about second terminal device configured maximum output power and/or information about second power headroom.

In a fourth aspect of the disclosure, there is provided a network device. The network device may comprise a processor and a memory coupled to the processor. Said memory contains instructions executable by said processor. Said network device is operative to receive a first power headroom report (PHR) from a terminal device,

In an embodiment, the first PHR may comprise first power headroom information for a first waveform and/or second power headroom information for a second waveform.

In an embodiment, the first power headroom information for the first waveform may comprise information about first terminal device configured maximum output power and/or information about first power headroom.

In an embodiment, the second power headroom information for the second waveform may comprise information about second terminal device configured maximum output power and/or information about second power headroom.

In a fifth aspect of the disclosure, there is provided a terminal device. The terminal device may comprise a first sending module configured to send a first power headroom report (PHR) to a network device.

In an embodiment, the first PHR may comprise first power headroom information for a first waveform and/or second power headroom information for a second waveform.

In an embodiment, the first power headroom information for the first waveform may comprise information about first terminal device configured maximum output power and/or information about first power headroom.

In an embodiment, the second power headroom information for the second waveform may comprise information about second terminal device configured maximum output power and/or information about second power headroom.

In an embodiment, the terminal device may further comprise a second sending module configured to send a second PHR to the network device. The second PHR may comprise power headroom information for a remaining waveform from the first waveform and the second waveform.

In an embodiment, the terminal device may further comprise a receiving module configured to receive a signaling indicating a waveform switching from the network device.

In an embodiment, the terminal device may further comprise a first comparing module configured to compare the first power difference Pₘₐₓ₁−P to a series of lower and upper values, thereby producing a first quantized value carried in the third part of the octet.

In an embodiment, the terminal device may further comprise a second comparing module configured to compare the second power difference Pₘₐₓ₂−P to the series of lower and upper values, thereby producing a second quantized value carried in the fourth part of the octet.

In an embodiment, the terminal device may further comprise a starting module configured to start or restart a PHR periodic timer and/or a PHR prohibit timer based on at least one of upon receiving a Radio Resource Control (RRC) or DCI signaling indicating a waveform switching from the network node, upon a start or end of a first Physical Uplink Shared Channel (PUSCH) transmission with a new switched waveform, or—upon RRC configuration or reconfiguration of dynamic waveform switching.

In a sixth aspect of the disclosure, there is provided a network device. The network device may comprise a first receiving module configured to receive a first power headroom report (PHR) from a terminal device.

In an embodiment, the first PHR may comprise first power headroom information for a first waveform and/or second power headroom information for a second waveform.

In an embodiment, the first power headroom information for the first waveform may comprise information about first terminal device configured maximum output power and/or information about first power headroom.

In an embodiment, the second power headroom information for the second waveform may comprise information about second terminal device configured maximum output power and/or information about second power headroom.

In an embodiment, the network device may further comprise a second receiving module configured to receive a second PHR from the terminal device. The second PHR may comprise power headroom information for a remaining waveform from the first waveform and the second waveform.

In an embodiment, the network device may further comprise a determining module configured to determine a waveform switching based on the first PHR and/or the second PHR.

In an embodiment, the network device may further comprise a sending module configured to send a signaling indicating a waveform switching to the terminal device.

In seventh aspect of the disclosure, there is provided a computer program product comprising instructions which when executed by at least one processor, cause the at least one processor to perform the method according to any one of the first or second aspect.

In an eighth aspect of the disclosure, there is provided a computer-readable storage medium storing instructions which when executed by at least one processor, cause the at least one processor to perform the method according to any one of the first or second aspect.

Embodiments herein may provide many advantages, of which a non-exhaustive list of examples follows. In some embodiments herein, it enables a terminal device to report the power headroom information for a target waveform. In some embodiments herein, it enables the terminal device to select a waveform from two waveforms, for which the UE reports its PHR first or only. In some embodiments herein, it enables the terminal device to know when to start or restart phr-PeriodicTimer and/or phr-ProhibitTimer. In some embodiments herein, the legacy PHR MAC CE for a waveform can be reused as much as possible. In some embodiments herein, a legacy field can be repurposed to indicate the power information related to the two waveforms. In some embodiments herein, the power difference quantization method is used to report power information for a waveform, which can enable fewer bits to be occupied. In some embodiments herein, it enables the terminal device to report power headroom information of two waveforms in a PHR MAC CE. In some embodiments herein, it enables the terminal device to report power headroom information of two waveforms in separate PHR MAC CEs. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 schematically shows a high level architecture in the fifth generation network according to an embodiment of the present disclosure;

FIG. 2a shows Single Entry PHR MAC CE;

FIG. 2b shows Enhanced Single Entry PHR MAC CE;

FIG. 2c shows Enhanced Multiple Entry PHR MAC CE with the highest ServCellIndex of Serving Cell with configured uplink is less than 8;

FIG. 2d shows Enhanced Single Entry PHR for multiple TRP MAC CE;

FIG. 2e shows an example of P_{CMAX,f,c} and required UE transmission power according to an embodiment of the present disclosure;

FIG. 3a shows a flowchart of a method according to an embodiment of the present disclosure;

FIG. 3b shows an example of PH of two waveforms in a PHR MAC CE according to an embodiment of the present disclosure;

FIG. 3c shows an example of P_{CMAX,f,c} of two waveforms in a PHR MAC CE according to an embodiment of the present disclosure;

FIG. 3d shows an example of updated Enhanced Single Entry PHR for multiple TRP MAC CE according to an embodiment of the present disclosure;

FIG. 4a shows a flowchart of a method according to another embodiment of the present disclosure;

FIG. 4b shows an example of power headroom information of two waveforms (WFs) in one PHR according to an embodiment of the present disclosure;

FIG. 4c shows an example of power headroom information of two WFs in two PHRs according to an embodiment of the present disclosure;

FIG. 4d shows an example of power headroom information of one prioritized WF according to an embodiment of the present disclosure;

FIG. 4e shows an example of cancellation of second PHR MAC CE according to an embodiment of the present disclosure;

FIG. 5a shows a flowchart of a method according to another embodiment of the present disclosure;

FIG. 5b shows a flowchart of a method according to another embodiment of the present disclosure;

FIG. 5c shows an example of how an example power headroom report can be structured using quantities according to an embodiment of the present disclosure;

FIG. 5d shows an example of how an example power headroom report can be structured using power difference quantized values for the two waveforms according to an embodiment of the present disclosure;

FIG. 5e shows a flowchart of a method according to another embodiment of the present disclosure;

FIG. 6 shows a flowchart of a method according to another embodiment of the present disclosure;

FIG. 7a shows a flowchart of a method according to an embodiment of the present disclosure;

FIG. 7b shows a flowchart of a method according to another embodiment of the present disclosure;

FIG. 8a is a block diagram showing an apparatus suitable for practicing some embodiments of the disclosure;

FIG. 8b is a block diagram showing a terminal device according to an embodiment of the disclosure;

FIG. 8c is a block diagram showing a network device according to an embodiment of the disclosure;

FIG. 9 shows an example of a communication system according to an embodiment of the disclosure;

FIG. 10 shows a UE in accordance with some embodiments;

FIG. 11 shows a network node in accordance with some embodiments;

FIG. 12 is a block diagram of a host according to an embodiment of the disclosure;

FIG. 13 is a block diagram illustrating a virtualization environment in which functions implemented by some embodiments may be virtualized; and

FIG. 14 shows a communication diagram of a host communicating via a network node with a UE over a partially wireless connection according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G, 6G communication protocols, and/or any other protocols either currently known or to be developed in the future.

The term “network device” or “network node” or “network function” refers to any suitable function which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure.

The network device may be an access network device with accessing function in a communication network via which a terminal device accesses to the network and receives services therefrom. The access network device may include a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), an Integrated Access and Backhaul (IAB) node, a remote radio head (RRH), a relay, a low power node such as a femto, a pico, and so forth.

Yet further examples of the access network device comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

Virtualizing means creating virtual versions of apparatuses or devices which may include virtualizing hardware platforms, storage devices and networking resources. As used herein, virtualization can be applied to a provider edge node and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments hosted by one or more of hardware nodes.

The functions may be implemented by one or more applications (which may alternatively be called software instances, virtual appliances, network functions, virtual nodes, virtual network functions, etc.) operative to implement some of the features, functions, and/or benefits of some of the embodiments disclosed herein. Applications are run in virtualization environment which provides hardware comprising processing circuitry and memory. Memory contains instructions executable by processing circuitry whereby application is operative to provide one or more of the features, benefits, and/or functions disclosed herein.

Virtualization environment, comprises general-purpose or special-purpose network hardware devices comprising a set of one or more processors or processing circuitry, which may be commercial off-the-shelf (COTS) processors, dedicated Application Specific Integrated Circuits (ASICs), or any other type of processing circuitry including digital or analog hardware components or special purpose processors. Each hardware device may comprise memory which may be non-persistent memory for temporarily storing instructions or software executed by processing circuitry. Each hardware device may comprise one or more network interface controllers (NICs), also known as network interface cards, which include physical network interface. Each hardware device may also include non-transitory, persistent, machine-readable storage media-having stored therein software and/or instructions executable by processing circuitry. Software may include any type of software including software for instantiating one or more virtualization layers (also referred to as hypervisors), software to execute virtual machines as well as software allowing it to execute functions, features and/or benefits described in relation with some embodiments described herein.

Virtual machines, comprise virtual processing, virtual memory, virtual networking or interface and virtual storage, and may be run by a corresponding virtualization layer or hypervisor. Different embodiments of the instance of virtual appliance may be implemented on one or more of virtual machines, and the implementations may be made in different ways.

During operation, processing circuitry executes software to instantiate the hypervisor or virtualization layer, which may sometimes be referred to as a virtual machine monitor (VMM). Virtualization layer may present a virtual operating platform that appears like networking hardware to virtual machine.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

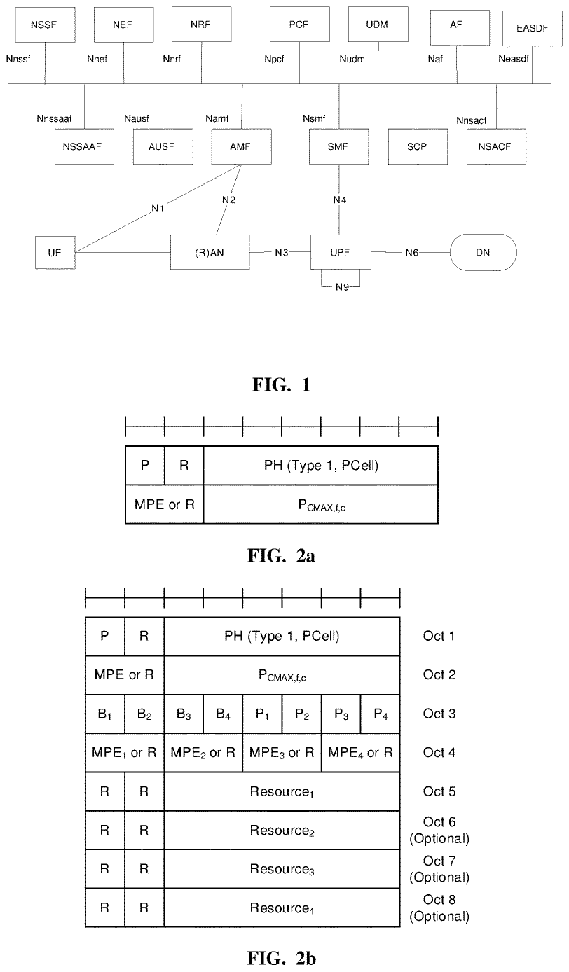

Although the subject matter described herein may be implemented in any appropriate type of system using any suitable components, the embodiments disclosed herein are described in relation to a communication system complied with the exemplary system architecture illustrated in FIG. 1. For simplicity, the system architecture of FIG. 1 only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

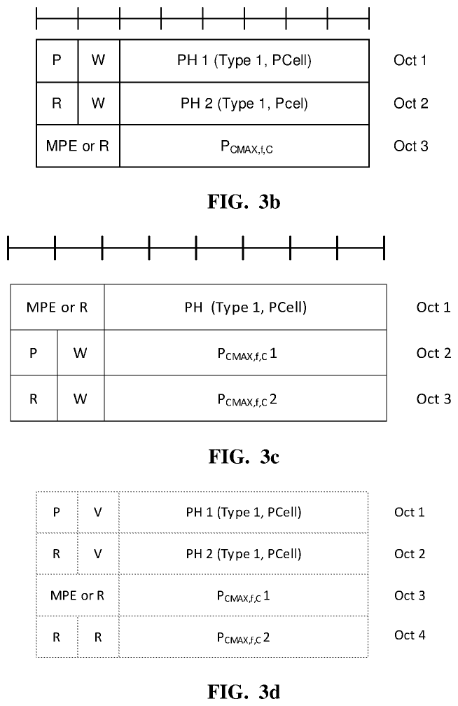

FIG. 1 schematically shows a high level architecture in the fifth generation network according to an embodiment of the present disclosure. For example, the fifth generation network may be 5G system (5GS). The architecture of FIG. 1 is same as FIG. 4.2.3-1 as described in 3GPP TS 23.501 V18.1.0, the disclosure of which is incorporated by reference herein in its entirety. The system architecture of FIG. 1 may comprise a plurality of network functions (NFs) such as Access and Mobility Management Function (AMF), Session Management Function (SMF), Authentication Service Function (AUSF), Unified Data Management (UDM), Policy Control Function (PCF), Application Function (AF), Network Exposure Function (NEF), User plane Function (UPF) and Network Repository Function (NRF), (radio) access network ((R)AN), service communication proxy (SCP), Network Slice Selection Function (NSSF), Network Slice-Specific Authentication and Authorization Function (NSSAAF), Edge Application Server Discovery Function (EASDF), NSACF (Network Slice Admission Control Function), etc.

In accordance with an exemplary embodiment, the UE can establish a signaling connection with the AMF over the reference point N1, as illustrated in FIG. 1. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the DN (data network, e.g. an operator network or Internet) through the UPF over the reference point N6.

As further illustrated in FIG. 1, the exemplary system architecture also contains the service-based interfaces such as Nnrf, Nnef, Nausf, Nudm, Npcf, Namf, Nnsacf, Neasdf and Nsmf exhibited by NFs such as the NRF, the NEF, the AUSF, the UDM, the PCF, the AMF, the NSACF, the EASDF and the SMF. In addition, FIG. 1 also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 1 may be responsible for functions such as session management, mobility management, authentication, security, etc. The AUSF, AMF, DN, NEF, NRF, NSSF, PCF, SMF, UDM, UPF, AF, UE, (R)AN, SCP, NSACF, NSSAAF, EASDF may include the functionality for example as defined in clause 6.2 of 3GPP TS 23.501 V18.1.0.

PHR may include various information such as UE configured maximum output power (e.g. P_{CMAX,c,f} as described in 3GPP 38.321 v17.8.0) together with the power headroom (PH). PHR may be transmitted by MAC CE.

Clause 5.4.6 of 3GPP TS38.321 V17.5.0 describes the Power Headroom Reporting as following.

The Power Headroom reporting procedure is used to provide the serving gNB with the following information:
Type 1 power headroom: the difference between the nominal UE maximum transmit power and the estimated power for UL-SCH transmission per activated Serving Cell;
Type 2 power headroom: the difference between the nominal UE maximum transmit power and the estimated power for UL-SCH and PUCCH transmission on SpCell of the other MAC entity (i.e. E-UTRA MAC entity in EN-DC, NE-DC, and NGEN-DC cases);
Type 3 power headroom: the difference between the nominal UE maximum transmit power and the estimated power for SRS transmission per activated Serving Cell;
MPE P-MPR: the power backoff to meet the MPE FR2 requirements for a Serving Cell operating on FR2.

RRC controls Power Headroom reporting by configuring the following parameters:
phr-PeriodicTimer;
phr-ProhibitTimer;
phr-Tx-PowerFactorChange;
phr-Type2OtherCell;
phr-ModeOtherCG;
multiplePHR;
mpe-Reporting-FR2;
mpe-ProhibitTimer;
mpe-Threshold;
numberOfN;
mpe-ResourcePool.

A Power Headroom Report (PHR) shall be triggered if any of the following events occur:
phr-ProhibitTimer expires or has expired and the path loss has changed more than phr-Tx-PowerFactorChange dB for at least one RS used as pathloss reference for one activated Serving Cell of any MAC entity of which the active DL BWP is not dormant BWP since the last transmission of a PHR in this MAC entity when the MAC entity has UL resources for new transmission;
NOTE 1: The path loss variation for one cell assessed above is between the pathloss measured at present time on the current pathloss reference and the pathloss measured at the transmission time of the last transmission of PHR on the pathloss reference in use at that time, irrespective of whether the pathloss reference has changed in between. The current pathloss reference for this purpose does not include any pathloss reference configured using pathlossReferenceRS-Pos in TS 38.331 [5].
phr-PeriodicTimer expires;
upon configuration or reconfiguration of the power headroom reporting functionality by upper layers, which is not used to disable the function;
activation of an SCell of any MAC entity with configured uplink of which firstActiveDownlinkBWP-Id is not set to dormant BWP;
activation of an SCG;
addition of the PSCell except if the SCG is deactivated (i.e. PSCell is newly added or changed);
phr-ProhibitTimer expires or has expired, when the MAC entity has UL resources for new transmission, and the following is true for any of the activated Serving Cells of any MAC entity with configured uplink:
   there are UL resources allocated for transmission or there is a PUCCH transmission on this cell, and the required power backoff due to power management (as allowed by P-MPR_{c} as specified in TS 38.101-1 [14], TS 38.101-2 [15], and TS 38.101-3 [16]) for this cell has changed more than phr-Tx-PowerFactorChange dB since the last transmission of a PHR when the MAC entity had UL resources allocated for transmission or PUCCH transmission on this cell.
Upon switching of activated BWP from dormant BWP to non-dormant DL BWP of an SCell of any MAC entity with configured uplink;
if mpe-Reporting-FR2 is configured, and mpe-ProhibitTimer is not running:
   the measured P-MPR applied to meet FR2 MPE requirements as specified in TS 38.101-2 [15] is equal to or larger than mpe-Threshold for at least one activated FR2 Serving Cell since the last transmission of a PHR in this MAC entity; or
   the measured P-MPR applied to meet FR2 MPE requirements as specified in TS 38.101-2 [15] has changed more than phr-Tx-PowerFactorChange dB for at least one activated FR2 Serving Cell since the last transmission of a PHR due to the measured P-MPR applied to meet MPE requirements being equal to or larger than mpe-Threshold in this MAC entity.
in which case the PHR is referred below to as ‘MPE P-MPR report’.

### PHR-Config Information Element

multiplePHR indicates if power headroom shall be reported using the Single Entry PHR MAC control element or Multiple Entry PHR MAC control element defined in 3GPP TS38.321 V17.5.0. True means to use Multiple Entry PHR MAC control element and False means to use the Single Entry PHR MAC control element defined in 3GPP TS38.321 V17.5.0. The network configures this field to true for Multi-Radio Dual Connectivity (MR-DC) and UL CA for NR, and to false in all other cases.

mpe-Reporting-FR2 indicates whether the UE shall report Maximum Permissible Exposure (MPE) Power Management UE Maximum Power Reduction (P-MPR) in the PHR MAC control element, as specified in 3GPP TS38.321 V17.5.0.

twoPHRMode indicates if the power headroom shall be reported as two PHRs (each PHR associated with a Sounding Reference Signal (SRS) resource set) is enabled or not.

phr-Tx-PowerFactorChange ENUMERATED {dB1, dB3, dB6, infinity}. phr-Tx-PowerFactorChange indicates value in dB for PHR reporting as specified in 3GPP TS38.321 V17.5.0. Value dB1 corresponds to 1 dB, dB3 corresponds to 3 dB and so on. The same value applies for each serving cell (although the associated functionality is performed independently for each cell).

Clause 5.4.6 of 3GPP TS38.321 V17.5.0 describes the selection of a PHR MAC CE format as following.

If the MAC entity has UL resources allocated for a new transmission the MAC entity shall:
1> if it is the first UL resource allocated for a new transmission since the last MAC reset:
   2> start phr-PeriodicTimer
1> if the Power Headroom reporting procedure determines that at least one PHR has been triggered and not cancelled; and
1> if the allocated UL resources can accommodate the MAC CE for PHR which the MAC entity is configured to transmit, plus its subheader, as a result of LCP as defined in clause 5.4.3.1:
   2> if multiplePHR with value true is configured:
      3> for each activated Serving Cell with configured uplink associated with any MAC entity of which the active DL BWP is not dormant BWP; and
      3> for each activated Serving Cell with configured uplink associated with E-UTRA MAC entity:
         4> obtain the value of the Type 1 or Type 3 power headroom for the corresponding uplink carrier as specified in clause 7.7 of TS 38.213 [6] for NR Serving Cell and clause 5.1.1.2 of TS 36.213 for E-UTRA Serving Cell;
         4> if this MAC entity has UL resources allocated for transmission on this Serving Cell; or
         4> if the other MAC entity, if configured, has UL resources allocated for transmission on this Serving Cell and phr-ModeOtherCG is set to real by upper layers:
         5> obtain the value for the corresponding P_{CMAX,f,c} field from the physical layer.
         5> if mpe-Reporting-FR2 is configured and this Serving Cell operates on FR2 and this Serving Cell is associated to this MAC entity:
         6> obtain the value for the corresponding MPE field from the physical layer.
      3> if phr-Type2OtherCell with value true is configured:
         4> if the other MAC entity is E-UTRA MAC entity:
         5> obtain the value of the Type 2 power headroom for the SpCell of the other MAC entity (i.e. E-UTRA MAC entity);
         5> if phr-ModeOtherCG is set to real by upper layers:
         6> obtain the value for the corresponding P_{CMAX,f,c} field for the SpCell of the other MAC entity (i.e. E-UTRA MAC entity) from the physical layer.
      3> instruct the Multiplexing and Assembly procedure to generate and transmit the Multiple Entry PHR MAC CE as defined in clause 6.1.3.9 based on the values reported by the physical layer.
   2> else (i.e. Single Entry PHR format is used):
      3> obtain the value of the Type 1 power headroom from the physical layer for the corresponding uplink carrier of the PCell;
      3> obtain the value for the corresponding P_{CMAX,f,c} field from the physical layer;
      3> if mpe-Reporting-FR2 is configured and this Serving Cell operates on FR2:
         4> obtain the value for the corresponding MPE field from the physical layer.
      3> instruct the Multiplexing and Assembly procedure to generate and transmit the Single Entry PHR MAC CE as defined in clause 6.1.3.8 based on the values reported by the physical layer.
   2> if this PHR report is an MPE P-MPR report:
      3> start or restart the mpe-ProhibitTimer;
      3> cancel triggered MPE P-MPR reporting for Serving Cells included in the PHR MAC CE.
   2> start or restart phr-PeriodicTimer;
   2> start or restart phr-ProhibitTimer;
   2> cancel all triggered PHR(s).
All triggered PHRs shall be cancelled when there is an ongoing SDT procedure as in clause 5.27 and the UL grant(s) can accommodate all pending data available for transmission but is not sufficient to additionally accommodate the PHR MAC CE plus its subheader.

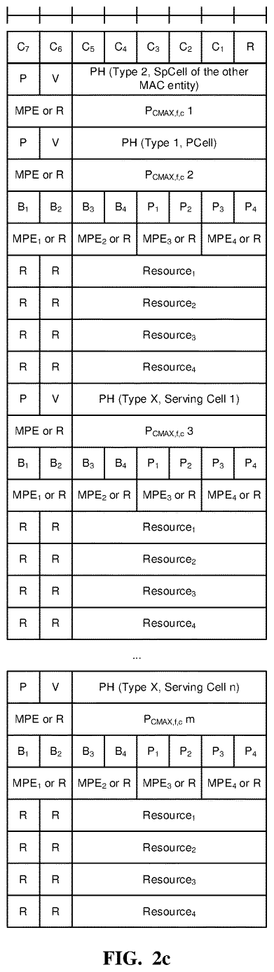

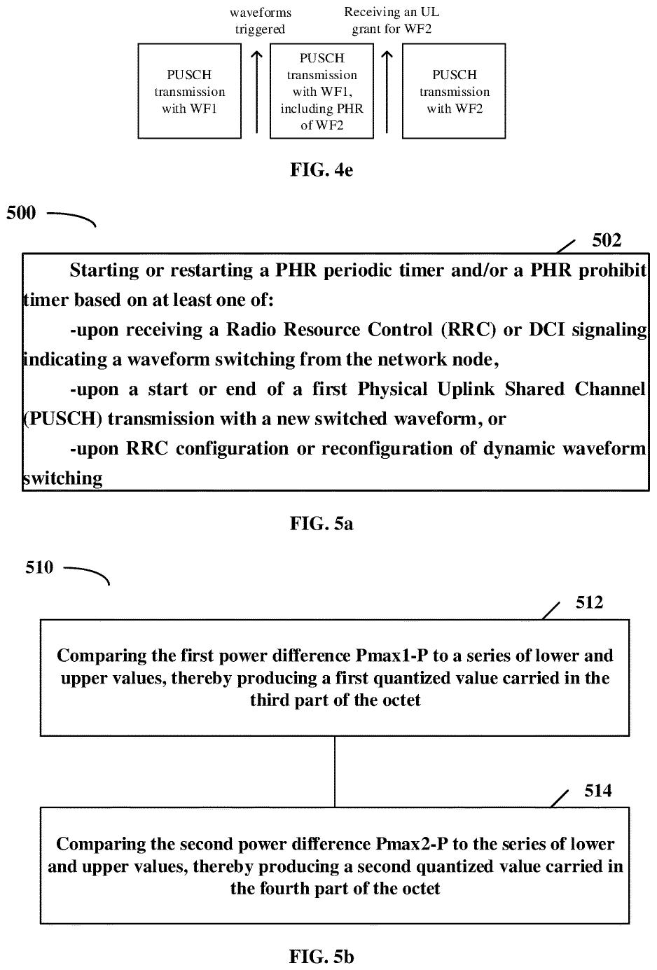

FIG. 2a shows Single Entry PHR MAC CE, which is same as FIG. 6.1.3.8-1 of 3GPP TS38.321 V17.5.0.

The legacy Single Entry PHR MAC CE has a fixed size and consists of two octets.

R denotes reserved bit, which is set to 0.

Power Headroom (PH) field indicates the power headroom level. The length of the PH field is 6 bits.

P: If mpe-Reporting-FR2 is configured and the Serving Cell operates on Frequency range 2 (FR2), the MAC entity shall set this field to 0 if the applied P-MPR value, to meet MPE requirements, is less than P-MPR_00 as specified in 3GPP TS 38.133 V17.8.0 and to 1 otherwise. If mpe-Reporting-FR2 is not configured or the Serving Cell operates on Frequency range 1 (FR1), this field indicates whether power backoff is applied due to power management. The MAC entity shall set the P field to 1 if the corresponding P_{CMAX,f,c} field would have had a different value if no power backoff due to power management had been applied.

P_{CMAX,f,c}: This field indicates the P_{CMAX,f,c} (as specified in 3GPP TS 38.213 V17.0.0) used for calculation of the preceding PH field.

MPE: If mpe-Reporting-FR2 is configured, and the Serving Cell operates on FR2, and if the P field is set to 1, this field indicates the applied power backoff to meet MPE requirements, as specified in 3GPP TS 38.101-2 V17.0.0. The length of the field is 2 bits. If mpe-Reporting-FR2 is not configured, or if the Serving Cell operates on FR1, or if the P field is set to 0, R bits are present instead.

More detailed description of Single Entry PHR MAC CE can be found in clause 6.1.3.8 of 3GPP TS38.321 V17.5.0, the description thereof is omitted here for brevity.

FIG. 2b shows Enhanced Single Entry PHR MAC CE, which is same as FIG. 6.1.3.48-1 of 3GPP TS38.321 V17.5.0. The Enhanced Single Entry PHR MAC CE has a variable size. More detailed description of Enhanced Single Entry PHR MAC CE can be found in clause 6.1.3.48 of 3GPP TS38.321 V17.5.0, the description thereof is omitted here for brevity.

FIG. 2c shows Enhanced Multiple Entry PHR MAC CE with the highest ServCellIndex of Serving Cell with configured uplink is less than 8, which is same as FIG. 6.1.3.49-1 of 3GPP TS38.321 V17.5.0. The Enhanced Multiple Entry PHR MAC CE has a variable size. More detailed description of Enhanced Multiple Entry PHR MAC CE can be found in clause 6.1.3.49 of 3GPP TS38.321 V17.5.0, the description thereof is omitted here for brevity.

FIG. 2d shows Enhanced Single Entry PHR for multiple TRP MAC CE, which is same as FIG. 6.1.3.50-1 of 3GPP TS38.321 V17.5.0.

The legacy Enhanced Single Entry PHR for multiple TRP MAC CE is designed for mTRP PUSCH transmissions, with one P_{CMAX,f,c} and two different pathloss estimates for the UL channels toward two TRPs. It has a fixed size and consists of three octets.

V: This field indicates if the PH value for the corresponding TRP is based on a real transmission or a reference format. For Type 1 PH, the V field set to 0 indicates real transmission on PUSCH and the V field set to 1 indicates that a PUSCH reference format is used.

More detailed description of Enhanced Single Entry PHR for multiple TRP MAC CE can be found in clause 6.1.3.50 of 3GPP TS38.321 V17.5.0, the description thereof is omitted here for brevity.

Table 6.1.3.8-1 of 3GPP TS 38.133 V17.8.0 describes Power Headroom levels for PHR.

TABLE 6.1.3.8-1
Power Headroom levels for PHR

| PH | Power Headroom Level |
|---|---|
| 0 | POWER_HEADROOM_0 |
| 1 | POWER_HEADROOM_1 |
| 2 | POWER_HEADROOM_2 |
| 3 | POWER_HEADROOM_3 |
| . . . | . . . |
| 60 | POWER_HEADROOM_60 |
| 61 | POWER_HEADROOM_61 |
| 62 | POWER_HEADROOM_62 |
| 63 | POWER_HEADROOM_63 |

Table 6.1.3.8-2 of 3GPP TS 38.133 V17.8.0 describes Nominal UE transmit power level for PHR.

TABLE 6.1.3.8-2
Nominal UE transmit power level for PHR

| P_{CMAX, f, c} | Nominal UE transmit power level |
|---|---|
| 0 | PCMAX_C_00 |
| 1 | PCMAX_C_01 |
| 2 | PCMAX_C_02 |
| . . . | . . . |
| 61 | PCMAX_C_61 |
| 62 | PCMAX_C_62 |
| 63 | PCMAX_C_63 |

Table 6.1.3.8-3 of 3GPP TS 38.133 V17.8.0 describes Effective power reduction for MPE P-MPR.

TABLE 6.1.3.8-3
Effective power reduction for MPE P-MPR

| MPE | Measured P-MPR value |
|---|---|
| 0 | P-MPR_00 |
| 1 | P-MPR_01 |
| 2 | P-MPR_02 |
| 3 | P-MPR_03 |

Table 10.1.17.1-1 of 3GPP TS 38.133 V17.8.0 describes Power headroom report mapping. The power headroom reporting range is from −32 . . . +38 dB.

TABLE 10.1.17.1-1
Power headroom report mapping

| | Measured quantity value |
|---|---|
| Reported value | (dB) |
| POWER_HEADROOM_0 | PH □ −32 |
| POWER_HEADROOM_1 | −32 □ PH □ −31 |
| POWER_HEADROOM_2 | −31 □ PH □ −30 |
| POWER_HEADROOM_3 | −30 □ PH □ −29 |
| □ | □ |
| POWER_HEADROOM_53 | 20 □ PH □ 21 |
| POWER_HEADROOM_54 | 21 □ PH □ 22 |
| POWER_HEADROOM_55 | 22 □ PH □ 24 |
| POWER_HEADROOM_56 | 24 □ PH □ 26 |
| POWER_HEADROOM_57 | 26 □ PH □ 28 |
| POWER_HEADROOM_58 | 28 □ PH □ 30 |
| POWER_HEADROOM_59 | 30 □ PH □ 32 |
| POWER_HEADROOM_60 | 32 □ PH □ 34 |
| POWER_HEADROOM_61 | 34 □ PH □ 36 |
| POWER_HEADROOM_62 | 36 □ PH □ 38 |
| POWER_HEADROOM_63 | PH ≥ 38 |

Table 10.1.18.1-1 of 3GPP TS 38.133 V17.8.0 describes Mapping of P_{CMAX,c,f}. The UE is required to report the UE configured maximum output power (P_{CMAX,c,f}) together with the power headroom. The P_{CMAX,c,f} reporting range is defined from −29 dBm to 33 dBm with 1 dB resolution.

TABLE 10.1.18.1-1
Mapping of P_{CMAX, c, f}

| Reported value | Measured quantity value | Unit |
|---|---|---|
| PCMAX_C_00 | P_{CMAX, c, f} < −29 | dBm |
| PCMAX_C_01 | −29 □ P_{CMAX, c, f} < −28 | dBm |
| PCMAX_C_02 | −28 □ P_{CMAX, c, f} < −27 | dBm |
| . . . | . . . | . . . |
| PCMAX_C_61 | 31 □ P_{CMAX, c, f} < 32 | dBm |
| PCMAX_C_62 | 32 □ P_{CMAX, c, f} < 33 | dBm |
| PCMAX_C_63 | 33 □ P_{CMAX, c, f} | dBm |

Clause 7.7 of 3GPP TS 38.213 V17.1.0 describes Power headroom report as following. A UE determines whether a power headroom report for an activated serving cell [11, TS 38.321] is based on an actual transmission or a reference format based on the higher layer signalling of configured grant and periodic/semi-persistent sounding reference signal transmissions and downlink control information the UE received until and including the PDCCH monitoring occasion where the UE detects the first DCI format 0_0 or DCI format 0_1 scheduling an initial transmission of a transport block since a power headroom report was triggered if the power headroom report is reported on a PUSCH triggered by the first DCI. Otherwise, a UE determines whether a power headroom report is based on an actual transmission or a reference format based on the higher layer signalling of configured grant and periodic/semi-persistent sounding reference signal transmissions and downlink control information the UE received until the first uplink symbol of a configured PUSCH transmission minus T′_{proc,2}=T_{proc,2} where T_{proc,2} is determined according to [6, TS 38.214] assuming d_{2,1}=1, d_{2,2=0}, and with μ_{DL} corresponding to the subcarrier spacing of the active downlink BWP of the scheduling cell for a configured grant if the power headroom report is reported on the PUSCH using the configured grant.

Clause 7.7.1 of 3GPP TS 38.213 V17.1.0 describes Type 1 PH report as following.
If a UE determines that a Type 1 power headroom report for an activated serving cell is based on an actual PUSCH transmission then, for PUSCH transmission occasion i on active UL BWP b of carrier f of serving cell c, the UE computes the Type 1 power headroom report as

$${PH}_{type 1 , b , f , c} ( i , j , {q}_{d} , l ) = {P}_{CMAX , f , c} ( i ) - \{ {P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) {Δ}_{TF , b , f , c} ( i ) + {f}_{b , f , c} ( i , l ) \} [ dB m ]$$

where

$${P}_{CMAX , f , c} ( i ) , {P}_{O \_ PUSCH , b , f , c} ( j ) , {M}_{RB , b , f , c}^{PUSCH} ( i ) , {α}_{b , f , c} ( j ) , {PL}_{b , f , c} ( {q}_{d} ) , {Δ}_{TF , b , f , c} ( i ) and {f}_{b , f , c} ( i , l )$$

are defined in Clause 7.1.1 of 3GPP TS 38.213 V17.1.0.
If the UE determines that a Type 1 power headroom report for an activated serving cell is based on a reference PUSCH transmission then, for PUSCH transmission occasion i on active UL BWP b of carrier f of serving cell c, the UE computes the Type 1 power headroom report as

PH_{type1,b,f,c}(i,j,q_{d},l)=\tilde{P}_{CMAX,f,c}(i)−{P_{O_PUSCH,b,f,c}(j)+α_{b,f,c}(j)·PL_{b,f,c}(q_{d})+f_{b,f,c}(i,l)}[dB]
where \tilde{P}_{CMAX,f,c}(i) is computed assuming MPR=0 dB, A-MPR=0 dB, P-MPR=0 dB. □T_{C}=0 dB. MPR, A-MPR, P-MPR and □T_{C} are defined in [8-1, TS 38.101-1], [8-2, TS38.101-2] and [8-3, TS 38.101-3]. The remaining parameters are defined in Clause 7.1.1 where P_{O_PUSCH,b,f,c}(j) and α_{b,f,c} (j) are obtained using P_{O_NOMINAL_PUSCH,f,c} (0) and p0-PUSCH-AlphaSetId=0, PL_{b,f,c}(q_{d}) is obtained using pusch-PathlossReferenceRS-Id=0, and l=0.

### MPE Triggered PHR Report

Due to adherence to the maximum permissible exposure (MPE) regulation, some UL coverage penalty is incurred as the UE ends up using a sub-optimal UL transmit beam. To alleviate this issue, some enhancement in the existing PHR report is introduced where beam-specific P-MPR along with the associated channel state information reference signal (CSI-RS) Resource Indicator (CRI)/Synchronization signal (SS)/Physical Broadcast Channel (PBCH) Block Resource indicator (SSBRI) is added into the MAC-CE-based PHR report.

### Dynamic Waveform Switching

In NR up to 3GPP Release 18, cyclic prefix (CP) orthogonal frequency division multiplexing (CP-OFDM) is the waveform supported in UL and DL. Discrete Fourier Transform spread OFDM (DFT-S-OFDM or DETS-OFDM) is supported for UL only. Because DFTS-OFDM has lower cubic metric/peak-to-average-power ratio (PAPR) than OFDM, and therefore superior coverage. A terminal must implement both OFDM and DFTS-OFDM, the network configures one. However, CP-OFDM is applicable for single and multiple layers of PUSCH transmission, while DFTS-OFDM supports only single layer PUSCH transmission.

UL waveform for PUSCH transmission is configured by RRC, and therefore UL waveform switching based on RRC reconfiguration is supported since NR Release 15. Dynamic UL waveform switching was proposed to Release 17 TEI proposals in 3GPP TSG RAN WG1 #106bis-e (R1-2109024), Oct. 11-19, 2021, with the following alternatives and not agreed. It was later included in Release 18 Further NR coverage enhancement WI.

R1-2109024 describes dynamic switching between DFT-s-OFDM and CP-OFDM as following.

To support dynamic switching of UL waveform, few alternatives can be considered.
Alt1: DCI signaling based dynamic UL waveform switching, it could be implicit or explicit
   Alt1-1: Explicit signaling, e.g. by introducing 1 bit in DCI to indicate CP-OFDM or DFT-s-OFDM waveform to be used for PUSCH
   Alt1-2: Implicit signaling, e.g. CP-OFDM or DFT-s-OFDM waveform to be used for PUSCH is identified by certain condition on the scheduling information in the DCI without changing DCI format.
Alt2: MAC CE signaling based dynamic UL waveform switching

Options of implicit signaling of UL waveform switching without changing DCI format:
Opt.1: waveform is DFT-S-OFDM if contiguous PRB allocation and multiple value of 2, 3, 5, else CP-OFDM.
Opt.2: waveform is DFT-S-OFDM if MCS is lower than threshold, else CP-OFDM.
Opt.3: waveform is CP-OFDM if PUSCH and DMRS is FDMed (based on ‘Number of DMRS CDM group(s) without data’), else DFT-S-OFDM.
Opt.4: waveform is CP-OFDM if more than one layer/rank are indicated, else DFT-S-OFDM.
One or multiple conditions can be used to determine whether the UE applies DFT-s-OFDM waveform in UL transmission.

According to Revised WID on Further NR coverage enhancements in 3GPP TSG RAN Meeting #96 (RP-221858), Budapest, Hungary, Jun. 6-9, 2022, an objective of the work item will specify enhancements to support dynamic switching between DFT-S-OFDM and CP-OFDM (RAN1).

### Need for an Enhanced Power Headroom Report and the Status Quo in 3GPP

A UE determines the PUSCH transmission power P_{PUSCH,b,f,c}(i, j, q_{d}, l) in a PUSCH transmission occasion i as follows.

$${P}_{PUSCH , b , f , c} ( i , j , {q}_{d} , l ) = min \{ \begin{matrix}{P}_{CMAX , f , c} ( i ) , \\ {P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) {Δ}_{TF , b , f , c} ( i ) + {f}_{b , f , c} ( i , l )\end{matrix} \} [ dB m ]$$

PUSCH transmission power is bounded by UE configured maximum output power, P_{CMAX,f,c}(i). If the required PUSCH transmission power determined by

$${P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) {Δ}_{TF , b , f , c} ( i ) + {f}_{b , f , c} ( i , l )$$

is larger than P_{CMAX,f,c}(i) of the current UL waveform CP-OFDM, the UE is power limited. In order to evaluate whether UL waveform switching can improve the UE's UL coverage, the network device such as gNB needs the information about the target waveform DFT-S-OFDM, e.g., if P_{CMAX,f,c} of DFT-S-OFDM is larger than the required PUSCH transmission power.

FIG. 2e shows an example of P_{CMAX,f,c} and required UE transmission power according to an embodiment of the present disclosure.

The solid line shows the required PUSCH transmission power, higher than P_{CMAX,f,c} of CP-OFDM. The two bars on its right side show two possible P_{CMAX,f,c} of DFT-S-OFDM. The middle bar is lower than the required PUSCH transmission power, so the UE would still be power limited after waveform switching. The rightmost bar is higher than the UE required PUSCH transmission power, and the UL waveform switching can improve UL coverage.

Agreement in 3GPP RAN1 #110b as described in summary #5 on dynamic switching between DFT-S-OFDM and CP-OFDM of 3GPP TSG RAN WG1 #113 (R1-2306255) is as following.

To study and if necessary, specify, enhancements to assist the scheduler in determining waveform switching, such as:
Reporting power headroom related information
Other solutions are not precluded

Agreement in 3GPP RAN1 #111 as described in summary #5 on dynamic switching between DFT-S-OFDM and CP-OFDM of 3GPP TSG RAN WG1 #113 (R1-2306255) is as following.

Study the necessity of the following potential enhancements to assist the scheduler in determining waveform switching:
Reporting power headroom related information based on P_{CMAX,f,c} applicable to a target waveform
   Target waveform can be same or different from waveform of an actual PUSCH transmission
   FFS target RB allocation and/or target modulation order can be same or different from respective properties of an actual PUSCH transmission
   FFS determination of target waveform, target RB allocation, target modulation order
   FFS details, e.g. report P_{CMAX,f,c} or Type 1 power headroom for a waveform, or difference thereof between waveforms
PHR triggering enhancements, e.g.
   Network-triggered PHR
   PH becomes lower (higher) than a threshold)
   PHR triggered by waveform switching
Reporting of recommended waveform or request to switch waveform
Other solutions not precluded

Agreement in 3GPP RAN1 #112b-e as described in summary #5 on dynamic switching between DFT-S-OFDM and CP-OFDM of 3GPP TSG RAN WG1 #113 (R1-2306255) is as following.

For potential enhancements to assist the scheduler in determining waveform switching, RAN1 to select 1 from the following options:
Option 1: Reporting of power headroom information for a reference PUSCH using target waveform different from waveform of actual PUSCH.
   Details for future study (FFS).
   Note: reporting PH information for both waveforms is not precluded.
   Note: additional trigger for PH for reference PUSCH is not precluded.
Option 2: New trigger of power headroom report based on waveform switching event.
   Details FFS.
Option 3: Both Option 1 and Option 2.
   Details FFS.
Option 4: No enhancement.

Agreement in 3GPP RAN1 #113 as described in summary #5 on dynamic switching between DFT-S-OFDM and CP-OFDM of 3GPP TSG RAN WG1 #113 (R1-2306255) is as following.

For potential enhancements to assist the scheduler in determining waveform switching, RAN1 to select 1 from the following options:
Option 1: Reporting of power headroom information for a reference PUSCH using target waveform different from waveform of actual PUSCH.
Details FFS.
   Note: Any MAC CE related decision is up to RAN2
Option 4: No enhancement.

In FL summary R1-2306255 in RAN1 #113 as described in summary #5 on dynamic switching between DFT-S-OFDM and CP-OFDM of 3GPP TSG RAN WG1 #113 (R1-2306255) is as following.
For the definition of “power headroom information”, need to decide if it is P_{CMAX,f,c}(i) only, PH only, or both. If RAN1 agrees that it is reported together with legacy Type 1 power headroom report, it may be directly defined as the difference between the P_{cmax} (or PH) of assumed and legacy.

FL proposal 3-2r5 in 3GPP RAN1 #113 as described in summary #5 on dynamic switching between DFT-S-OFDM and CP-OFDM of 3GPP TSG RAN WG1 #113 (R1-2306255) is as following.

For potential enhancements to assist the scheduler in determining waveform switching, RAN1 to select one from the following options:
Option 1: Reporting of power headroom information for an assumed PUSCH using target waveform different from waveform of actual PUSCH.
   Power headroom information for assumed PUSCH is based on an actual PUSCH transmission.
      In case of no actual PUSCH transmission on a serving cell, power headroom information for assumed PUSCH is not supported.
      DWS field needs to be configured for at least one DCI format for the BWP of the actual PUSCH, otherwise power headroom information for assumed PUSCH is not supported.
      FFS: If actual PUSCH transmission is not scheduled by a DCI with DWS field, power headroom information for assumed PUSCH is not supported.
   If actual PUSCH transmission is with DFT-S-OFDM waveform, UE computes power headroom information of an assumed PUSCH with CP-OFDM waveform. If actual PUSCH transmission is with CP-OFDM waveform, UE computes power headroom information of an assumed PUSCH with DFT-S-OFDM waveform.
      All parameters that are used for the calculation of P_{CMAX,f,c}(i), except waveform, are the same between assumed PUSCH and actual PUSCH.
      In case assumed PUSCH transmission is not supported for the parameters that are used for the calculation of P_{CMAX,f,c}(i), power headroom information for assumed PUSCH is not computed or reported.
   Power headroom information for assumed PUSCH includes the following:
      P_{CMAX,f,c}(i) of assumed PUSCH
         Accounting for applicable MPR, A-MPR and P-MPR for the assumed PUSCH.
   Power headroom information for assumed PUSCH is supported at least if multiplePHR-False and twoPHRmode is not enabled. FFS: other cases.
   For a serving cell with power headroom information of assumed PUSCH to be reported, support only one of alternatives below:
      Alt 1: Power headroom information for assumed PUSCH and legacy Type 1 PH are reported together.
      Alt 2: Only power headroom information for assumed PUSCH is reported.
   RAN1 assumes the following RAN2 impacts and design aspects to be decided by RAN2:
      Trigger/condition for reporting power headroom information for assumed PUSCH.
      Design of MAC CE(s) for the reporting of power headroom information for assumed PUSCH, including whether P_{CMAX,f,c}(i) of assumed PUSCH is reported directly or as difference from P_{CMAX,f,c}(i) of actual PUSCH.
   Send LS to RAN2 (cc RAN4) if Option 1 is selected.
Option 4: No enhancement.

Proposal #2 in 3GPP RAN #100 is as following.
RAN provide guidance to RAN1/2 on dynamic waveform switching objective as below
RAN1 will decide whether to define any PHR enhancement for dynamic waveform switching and to provide the details to RAN2 by August meeting
RAN2 will not work on PHR triggering procedure for dynamic waveform switching in Rel-18 UL Coverage enh WI

In NR up to 3GPP release 17, the PHR of a current PUSCH waveform can be triggered periodically, for example when a PHR Periodic Timer (e.g., phr-PeriodicTimer as defined in 3GPP TS 38.321 V17.5.0, the disclosure of which is incorporated by reference herein in its entirety) expires, and by some events, for example when the path loss has changed more than PHT transmission Power Factor Change (e.g., phr-Tx-PowerFactorChange as defined in 3GPP TS 38.321 V17.0.) dB since the last transmission of a PHR in this MAC entity. There are multiple PHR MAC CE formats for single carrier, UL CA, and mTRP, with fixed or variable sizes. Nevertheless, Type 1 power headroom reported in the legacy PHR MAC CE is always based on the currently configured PUSCH waveform.

Power headroom report of a target waveform was agreed as a potential enhancement to assist network device determination of dynamic waveform switching in 3GPP release 18. The agreement in 3GPP RAN #100 “RAN2 will not work on PHR triggering procedure for dynamic waveform switching in Rel-18 UL Coverage enh WI” implies that the legacy PHR triggering events are to be reused for the enhanced PHR. In other words, when a legacy PHR triggering event occurs, the power headroom report of both the current waveform and the target waveform is triggered. However, there is no disclosed design of a PHR MAC CE including power headroom information of two waveforms.

To overcome or mitigate at least one of above mentioned problems or other problems, the embodiments of the present disclosure propose an improved solution for power headroom reporting.

In an embodiment, there is provided a method of UE reporting power headroom information of the target waveform.

In an embodiment, power headroom information of two waveforms can be reported in a PHR MAC CE and a method for designing the PHR MAC CE, e.g., including new fields, value range, or by repurposing, is provided.

In an embodiment, power headroom information of two waveforms can be reported in separate PHR MAC CEs and a method for selecting a waveform for which the UE reports its PHR first or only is provided.

In an embodiment, a method of impact of dynamic waveform switching on the legacy PHR timers is provided.

In an embodiment, since power control does not change, UE can only report one of the PH, P_{cmax}, or the change in power for the other waveform.

In an embodiment, a method in a UE of reporting an available power according to whether the UE would transmit with a first or a second waveform may comprise:
a. Determining a first maximum power that the UE can use for transmission with the first waveform;
b. Determining a first power headroom corresponding to the first waveform;
c. Determining a second power value that is one of
   i. a second maximum power that the UE can use for transmission with the second waveform,
   ii. a second power headroom that the UE can use for transmission with the second waveform, and
   iii. a difference between the power that the UE can use for transmission for the first and second waveform; and
d. providing indications of the first maximum power, the power headroom, and the second power value in a report.

In an embodiment, the first waveform is determined as the current waveform.

In an embodiment, the first waveform may be the waveform most recently used for transmission.

In an embodiment, UE may select which of the two waveforms it will report P_{cmax} and PH for according to if the most recent waveform used had a negative PH.

In an embodiment, a method in a UE of reporting an available power according to whether the UE would transmit with a first or a second waveform may comprise:
a) Determining a first power headroom corresponding to a waveform most recently used for transmission
b) If the first power headroom is negative,
   i. selecting a waveform for reporting as the second waveform,
   ii. determining a selected power headroom and a selected maximum power according to transmissions using the second waveform;
c) If the first power headroom is not negative,
   iii. selecting the waveform for reporting as the first waveform,
   iv. determining the selected power headroom as the first power headroom;
   v. determining the selected maximum power according to transmissions using the first waveform; and
d) providing indications of the selected waveform, maximum power, and power headroom in a report.

In an embodiment, a PHR may comprise multiple quantized differences between P_{max,f,c} corresponding to different transmission conditions and a power value.

In an embodiment, a method in a UE of reporting a plurality of maximum powers available for transmission may comprise:
a) Determining a first and a second value maximum power value Pₘₐₓ₁ and Pₘₐₓ₂, according to different transmission conditions for a physical channel
b) Determining a first and a second power difference, Pₘₐₓ₁−P and Pₘₐₓ₂−P, respectively, from a predetermined power value, P, wherein the value P is at least one of
   vi. a power corresponding to a power class of the UE, and
   vii. a power level configured to the UE for the purpose of power headroom reporting.
c) Comparing the first power difference Pₘₐₓ₁−P to a series of lower and upper values, thereby producing a first quantized value;
d) Comparing the second power difference Pₘₐₓ₂−P to the series of lower and upper values, thereby producing a second quantized value;
e) Providing the first and second quantized values in a power headroom report together with a power headroom.

In an embodiment, quantizing corresponds to comparing the power difference against upper and/or lower thresholds.

In an embodiment, a method may comprise producing a first quantized value if Pₘₐₓ₁−P is greater than or equal to a first lower value of the lower values and if Pₘₐₓ₁−P is less than a first upper value of the upper values, and producing a second quantized value if Pₘₐₓ₁−P is greater than or equal to a second lower value of the lower values and if Pₘₐₓ₁−P is less than a second upper value of the upper values.

In an embodiment, a first and a second transmission condition correspond to at least one of:
a) transmitting with a first and a second waveform, respectively,
b) transmitting on a first and a second carrier, respectively, and
c) transmitting a first and a second physical channel or physical signal, respectively.

In an embodiment, a method may comprise transmitting using a waveform corresponds to one of transmitting a physical channel with transform precoding enabled or disabled.

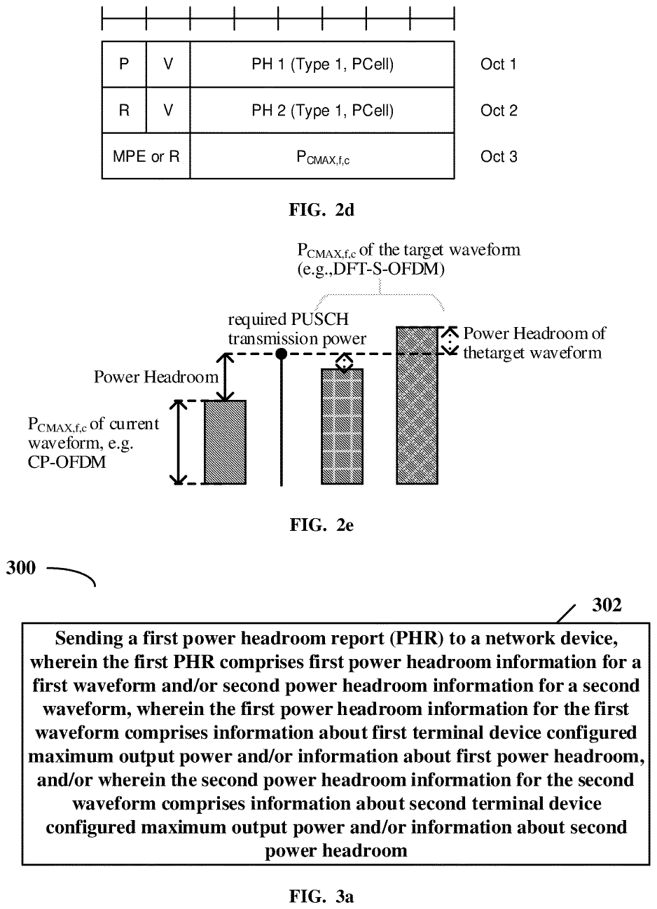

FIG. 3a shows a flowchart of a method according to an embodiment of the present disclosure, which may be performed by an apparatus implemented in or at or as a terminal device or communicatively coupled to the terminal device. As such, the apparatus may provide means or modules or circuits for accomplishing various parts of the method 300 as well as means or modules or circuits for accomplishing other processes in conjunction with other components.

At block 302, the terminal device may send a first power headroom report (PHR) to a network device.

The PHR may be triggered in various ways and the present disclosure has no limit on it. For example, the triggering events may be that as described in clause 5.4.6 of 3GPP TS38.321 V17.5.0 and the PHR may be triggered if any of the some events occur. In addition to the triggering events as described in clause 5.4.6 of 3GPP TS38.321 V17.5.0, new triggering events may be defined. Alternatively, some of the triggering events as described in clause 5.4.6 of 3GPP TS38.321 V17.5.0 may be removed.

The first PHR may comprise any suitable information related to power headroom of waveform. The first PHR may comprise power headroom information of any suitable number of waveforms, such as two or more waveforms. The waveform may be any suitable waveform e.g. which can be used in uplink. The waveform may be currently used waveform (or current waveform), target waveform, candidate waveform, etc.

For example, the current waveform may be, when a PHR triggering event occurs, the waveform of the uplink (e.g. PUSCH) transmission in which PHR will be carried on. The target waveform and/or the candidate waveform may be the one different from the current waveform. The target waveform and/or the candidate waveform can be a target or candidate waveform in UL waveform switching.

In an embodiment, the first PHR may comprise first power headroom information for a first waveform and/or second power headroom information for a second waveform,

The power headroom information of a waveform may comprise any suitable information which can be used to indicate or determine or compute the power headroom information of the waveform.

The first waveform may be any suitable waveform such as currently used waveform, target waveform, candidate waveform, etc.

The second waveform may be any suitable waveform such as currently used waveform, target waveform, candidate waveform, etc.

In an embodiment, the first waveform may be CP-OFDM and the second waveform may be DFT-S-OFDM.

In an embodiment, the first waveform may be DFT-S-OFDM and the second waveform may be CP-OFDM.

In an embodiment, the first waveform may be a current waveform and the second waveform may be a target waveform.

In an embodiment, the first waveform may be a target waveform and the second waveform may be a current waveform.

In an embodiment, the first power headroom information for the first waveform may comprise information about first terminal device configured maximum output power and/or information about first power headroom.

In an embodiment, the second power headroom information for the second waveform may comprise information about second terminal device configured maximum output power and/or information about second power headroom.

The first/second terminal device configured maximum output power may be UE configured maximum output power for example as described in various 3GPP specifications. The first/second terminal device configured maximum output power may be determined in various ways and the present has no limit on it. In an embodiment, the first/second terminal device configured maximum output power may be P_{CMAX,f,c}(i) which is the UE configured maximum output power defined in [8-1, 3GPP TS 38.101-1 V18.2.0], [8-2, 3GPP TS38.101-2 V18.2.0] and [8-3, 3GPP TS38.101-3 V18.2.0] for carrier f of serving cell c in PUSCH transmission occasion i.

The information about first/second terminal device configured maximum output power may be any suitable information which can be used to indicate or determine or compute the first/second terminal device configured maximum output power. The information about first/second terminal device configured maximum output power may be information indicating the first/second terminal device configured maximum output power or information indicating a difference between the first/second terminal device configured maximum output power and a predefined or configured value or information indicating a difference between the first terminal device configured maximum output power and the second terminal device configured maximum output power. For example, the information about first/second terminal device configured maximum output power may be a reported value for example as described in various 3GPP specifications such as 3GPP TS38.133 V17.8.0.

The power headroom may be the power headroom for example as described in various 3GPP specifications. The power headroom may be determined in various ways and the present has no limit on it. For example, the power headroom may be computed according to various 3GPP specifications such as 3GPP TS38.213 V17.1.0.

The information about first/second power headroom may be any suitable information which can be used to indicate or determine or compute the first/second power headroom. The information about first/second power headroom may be information indicating the first/second power headroom or information indicating a difference between the first/second power headroom and a predefined or configured value or information indicating a difference between the first power headroom and the second power headroom. For example, the information about first/second power headroom may be a reported value for example as described in various 3GPP specifications such as 3GPP TS38.133 V17.8.0.

In an embodiment, the first PHR may comprise the information about the first terminal device configured maximum output power, the information about the second terminal device configured maximum output power and one of the information about the first power headroom and the information about the second power headroom.

In an embodiment, the first PHR may comprise the information about the first power headroom, the information about the second power headroom and one of the information about the first terminal device configured maximum output power and the information about the second terminal device configured maximum output power.

For example, quote from FL summary R1-2306255 in RAN1 #113:
For the definition of “power headroom information”, need to decide if it is P_{CMAX,f,c}(i) only, PH only, or both. If RAN1 agrees that it is reported together with legacy Type 1 power headroom report, it may be directly defined as the difference between the P_{cmax} (or PH) of assumed and legacy.

Regarding “need to decide if it is P_{CMAX,f,c}(i) only, PH only, or both.”, UE reporting both of PH and P_{CMAX,f,c} of the target waveform is redundant. Although two waveforms may result in two P_{CMAX,f,c}, the same pathloss estimate is used for calculation of PH (power headroom) of the current waveform and PH of the target waveform. Note: current waveform is, when a PHR triggering event occurs, the waveform of the PUSCH transmission in which PHR will be carried on. Target waveform is the one different from the current waveform. Therefore, the difference between power headroom of two waveforms is exactly the same as the difference between P_{CMAX,f,c} of two waveforms. If information of both waveforms is reported together, it is sufficient for a UE to report one of P_{CMAX,f,c} and PH for the target waveform. In other words, if a PHR includes P_{CMAX,f,c} of two waveforms, PH is calculated based on the current waveform; if a PHR includes PH of two waveforms, P_{CMAX,f,c} is calculated based on the current waveform.

In an embodiment, the first PHR may comprise first waveform indication information associated with the information about the first power headroom information and/or second waveform indication information associated with the information about the second power headroom information.

The first/second waveform indication information may be any suitable information which can be used to indicate the first/second waveform. For example, the first/second waveform indication information may be explicit information or implicit information. The explicit information may be a bit, a flag, an indication, etc. The implicit information may be a predefined rule or order. For example, the first waveform indication information may be explicit information and the second waveform may be explicit information or implicit information. The first waveform indication information may be implicit information and the second waveform may be explicit information or implicit information.

In an embodiment, the first waveform indication information and/or the second waveform indication information may be indicated by at least one of a bit of a new field in a PHR medium access control (MAC) control element (CE), a bit of an existing field in a PHR MAC CE, or a predefined rule.

The PHR MAC CE may be similar to the PHR MAC CE as described in 3GPP TS 38.321 V17.5.0. For example, the new field may be added in the PHR MAC CE to indicate the first waveform indication information or the second waveform indication information. The bit of the existing field in the PHR MAC CE may be used to indicate the first waveform indication information or the second waveform indication information.

In an embodiment, the existing field in the PHR MAC CE may comprise a reserved field. For example, any suitable reserved field in the PHR MAC CE as described in 3GPP TS 38.321 V17.5.0 may be used to indicate the first waveform indication information or the second waveform indication information.

The predefined rule may be any suitable rule which can be used to indicate the first waveform indication information or the second waveform indication information.

In an embodiment, the predefined rule may comprise at least one of the second power headroom information may be appended after the first power headroom information, the information about second terminal device configured maximum output power for the second waveform may be appended after the information about the first terminal device configured maximum output power, or the information about the second power headroom for the second waveform may be appended after the information about the first power headroom for the first waveform.

In an embodiment, the information about the second terminal device configured maximum output power or the information about the second power headroom for the second waveform may be appended after an existing PHR MAC CE format for multiple transmission reception point. The existing PHR MAC CE format may comprise the first terminal device configured maximum output power and the first power headroom for the first waveform. For example, the existing PHR MAC CE format may be that for example as described in 3GPP TS 38.321 V17.5.0.

For example, PHR with information of two waveforms can be supported by either a new MAC CE format(s) or updating the legacy MAC CE formats by adding a new field/repurposing an existing field. Adding a new field related to the target waveform would result in a larger size, therefore the information of the target waveform can be added to PHR MAC CE formats with variable sizes, including Enhanced Single Entry PHR MAC CE, Enhanced Multiple Entry PHR MAC CE, Enhanced Multiple Entry PHR for multiple TRP MAC CE as described in 3GPP TS 38.321 V17.5.0. Repurposing a field, including the reserved field, has the merit of keeping the same payload size and is more suitable with PHR MAC CE formats with fixed sizes.

Embodiment 1, if a PHR includes P_{CMAX,f,c} of two waveforms or PH of two waveforms, the waveform based on which P_{CMAX,f,c} or PH is calculated is indicated by one or more of the following options.

FIG. 3b shows an example of PH of two waveforms in a PHR MAC CE according to an embodiment of the present disclosure.

FIG. 3c shows an example of P_{CMAX,f,c} of two waveforms in a PHR MAC CE according to an embodiment of the present disclosure.
Option 1, the value of a new field indicates a specific waveform . . . . For example, as shown in FIGS. 3b and 3c, W field set to 0 may indicate DFT-S-OFDM, and the W field set to 1 may indicate CP-OFDM.
Option 2, as shown in FIGS. 3b and 3c, the value of W field may indicate the current or target waveform. E.g., W field set to 0 in FIG. 3b may indicate the current waveform, and the W field set to 1 in FIG. 3b may indicate the target waveform.
Option 3, the P_{CMAX,f,c} or PH of the target waveform may be appended after the fields of the current waveform.
Option 4, if the PHR MAC CE includes P_{CMAX,f,c} or PH of two waveforms, information of one specific waveform is always ahead of that of the other waveform in the PHR MAC CE. For example, P_{CMAX,f,c} or PH of DFT-S-OFDM may be put ahead of that of CP-OFDM.
Option 1 and Option 2 may be suitable for a new PHR MAC CE format. Option 3 and Option 4 may work better if a new field for the power headroom information of target waveform is added in the legacy PHR MAC CE formats.

For mTRP PUSCH repetition, a UE may report power headroom information in one or two PHR MAC CE based on twoPHRmode. To support its interaction with dynamic waveform switching, P_{CMAX,f,c} or PH of the target waveform can be added as a new field in the existing PHR MAC CE format for multiple TRP.

FIG. 3d shows an example of updated Enhanced Single Entry PHR for multiple TRP MAC CE according to an embodiment of the present disclosure. As shown in FIG. 3d, P_{CMAX,f,c} 1 may be associated with the current waveform, and P_{CMAX,f,c} 2 associated with the target waveform may be appended. An explicit indication of waveform is not needed.

In an embodiment, the information about the first terminal device configured maximum output power for the first waveform may comprise information indicating the first terminal device configured maximum output power, or information indicating a first difference of the first terminal device configured maximum output power and a first power value and the information about the second terminal device configured maximum output power for the second waveform may comprise information indicating a second terminal device configured maximum output power, or information indicating a second difference of the first terminal device configured maximum output power and the second terminal device configured maximum output power, or information indicating a third difference of the second terminal device configured maximum output power and the first power value.

In an embodiment, the information about the first power headroom for the first waveform may comprise information indicating the first power headroom, or information indicating a fourth difference of the first power headroom and a second power value and the information about the second power headroom for the second waveform may comprise information indicating the second power headroom, or information indicating a fifth difference of the first power headroom and the second power headroom, or information indicating a sixth difference of the second power headroom and the second power value.

The first power value and/or the second power value may be any suitable value and can be determined in various ways. In an embodiment, the first power value and/or the second power value may comprise at least one of a nominal power of a power class of the terminal device, a configured value, or a predetermined value. For example, the network node may send the configured value to the terminal device. For example, the predetermined value may be determined by an operator or using machine learning.

For example, regarding “If RAN1 agrees that it is reported together with legacy Type 1 power headroom report, it may be directly defined as the difference between the P_{cmax} (or PH) of assumed and legacy” quoted from FL summary R1-2306255 in RAN1 #113, in addition to UE reporting the value of P_{CMAX,f,c} or PH of the target waveform, it is also possible that a UE reports the difference of P_{CMAX,f,c} or PH between the two waveforms.

For example, the legacy power headroom reporting range is from −32 . . . +38 dB, with 1 dB or 2 dB resolution. The P_{CMAX,c,f} reporting range is from −29 dBm to 33 dBm with 1 dB resolution. If a difference of PH or P_{CMAX,f,c} between two waveforms is reported, the largest difference can happen when a UE applies maximum power reduction (MPR) for CP-OFDM and 0 dB power reduction for DFT-S-OFDM. According to Table 6.2.2-1 in 3GPP TS38.101-1 V18.2.0, with the same resource block (RB) allocation and modulation order, the difference can be at most 3 dB for Quadrature Phase Shift Keying (QPSK) and 16 Quadrature Amplitude Modulation (QAM), 3.5 dB for 64QAM, and 6.5 dB for 256QAM. This difference doesn't take into account additional maximum power reduction (A-MPR). With UL CA configured, 8 dB is the largest MPR for CP-OFDM. Similarly, according to Table 6.2.2.3-1 in 3GPP TS 38.101-2 V18.2.0, for FR2-1, the difference between two waveforms can be at most 4 dB, 5 dB, and 7.5 dB for QPSK, 16QAM, and 64QAM.

TABLE 6.2.2-1
Maximum power reduction (MPR) for power class 3

MPR (dB)

| | Edge RB | Outer RB | Inner RB |
|---|---|---|---|
| Modulation | allocations | allocations | allocations |

| | | | | |
|---|---|---|---|---|
| DFT-s- | Pi/2 BPSK | ≤3.5¹ | ≤1.2¹ | ≤0.2¹ |
| OFDM | | ≤0.5² | ≤0.5² | 0² |
| | Pi/2 BPSK w | ≤0.5² | 0² | 0² |
| | Pi/2 BPSK | | | |
| | DMRS | | | |

| | QPSK | ≤1 | 0 |
|---|---|---|---|
| | 16 QAM | ≤2 | ≤1 |
| | 64 QAM | ≤2.5 | |
| | 256 QAM | ≤4.5 | |
| CP- | QPSK | ≤3 | ≤1.5 |
| OFDM | 16 QAM | ≤3 | ≤2 |

| | |
|---|---|
| 64 QAM | ≤3.5 |
| 256 QAM | ≤6.5 |

NOTE 1:
Applicable for UE operating in TDD mode with Pi/2 BPSK modulation and UE indicates support for UE capability powerBoosting-pi2BPSK and if the IE powerBoostPi2BPSK is set to 1 and 40% or less slots in radio frame are used for UL transmission for bands n40, n41, n77, n78 and n79. The reference power of 0 dB MPR is 26 dBm.
NOTE 2:
Applicable for UE operating in FDD mode, or in TDD mode in bands other than n40, n41, n77, n78 and n79 with Pi/2 BPSK modulation and if the IE powerBoostPi2BPSK is set to 0 and if more than 40% of slots in radio frame are used for UL transmission for bands n40, n41, n77, n78 and n79.

TABLE 6.2.2.3-1
MPR_{WT} for power class 3, BWchannel ≤ 200 MHz, FR2-1

MPR_{WT}, BW_{channel} ≤ 200 MHz

| | | Inner RB allocations, | Edge RB |
|---|---|---|---|
| Modulation | | Region 1 | allocations |
| DFT-s- | Pi/2 | 0.0 | ≤2.0 |
| OFDM | BPSK | | |
| | QPSK | 0.0 | ≤2.0 |
| | 16 QAM | ≤3.0 | ≤3.5 |
| | 64 QAM | ≤5.0 | ≤5.5 |
| CP-OFDM | QPSK | ≤3.5 | ≤4.0 |
| | 16 QAM | ≤5.0 | ≤5.0 |
| | 64 QAM | ≤7.5 | ≤7.5 |

Embodiment 2, a UE can report the difference between P_{CMAX,f,c} of the two waveforms with one or more of the following.
Option 1, P_{CMAX,f,c} of target waveform−P_{CMAX,f,c}, of current waveform
Option 2, (P_{CMAX,f,c} of waveform 1)−(P_{CMAX,f,c} of waveform 2), where waveform 1 and waveform 2 are predetermined. For example, waveform 1 is predetermined as DFT-S-OFDM.

A variant of Embodiment 2 is that if the difference between PH of the two waveforms is reported, P_{CMAX,f,c} in the abovementioned two options is replaced with PH.

Usually P_{CMAX,f,c} of DFT-S-OFDM is larger than P_{CMAX,f,c} of CP-OFDM. Given that waveform switching may happen in both directions, from CP-OFDM to DFT-S-OFDM and vice versa, with Option 1, the reported difference is positive in one direction and negative in another. The reported difference in Option 2 is mostly positive if waveform 1 is CP-OFDM, and otherwise, mostly negative. Therefore, Option 1 requires a larger value range than Option 2.

Table 1 shows an example of value range of 0 dB to 3 dB with a 0.5 dB resolution.

TABLE 1
Mapping of P_{CMAX, c, f} difference

| Reported value | Measured quantity value | Unit |
|---|---|---|
| PCMAX_C_DIFFERENCE_00 | P_{CMAX, c, f} of DFT-S-OFDM − | dB |
| | P_{CMAX, c, f} of CP-OFDM < 0 | |
| PCMAX_C_DIFFERENCE_01 | 0 ≤ P_{CMAX, c, f} of DFT-S-OFDM − | dB |
| | P_{CMAX, c, f} of CP-OFDM < 0.5 | |
| PCMAX_C_DIFFERENCE_02 | 0.5 ≤ P_{CMAX, c, f} of DFT-S-OFDM − | dB |
| | P_{CMAX, c, f} of CP-OFDM < 1 | |
| . . . | | . . . |
| PCMAX_C_DIFFERENCE_6 | 2.5 ≤ P_{CMAX, c, f} of DFT-S-OFDM − | dB |
| | P_{CMAX, c, f} of CP-OFDM < 3 | |
| PCMAX_C_DIFFERENCE_7 | 3 ≤ P_{CMAX, c, f} of DFT-S-OFDM − | dB |
| | P_{CMAX, c, f} of CP-OFDM < 3.5 | |

Table 2 shows an example of value range of −3 dB to 3 dB with a 1 dB resolution.

TABLE 2
Mapping of P_{CMAX, c, f} difference

| Reported value | Measured quantity value | Unit |
|---|---|---|
| PCMAX_C_DIFFERENCE_00 | P_{CMAX, c, f} of target waveform − | dB |
| | P_{CMAX, c, f} of current waveform < −3 | |
| PCMAX_C_DIFFERENCE_01 | −3 ≤ P_{CMAX, c, f} of target waveform − | dB |
| | P_{CMAX, c, f} of current waveform < −2 | |
| PCMAX_C_DIFFERENCE_02 | −2 ≤ P_{CMAX, c, f} of target waveform − | dB |
| | P_{CMAX, c, f} of current waveform < −1 | |
| . . . | | . . . |
| PCMAX_C_DIFFERENCE_05 | 1 ≤ P_{CMAX, c, f} of target waveform − | dB |
| | P_{CMAX, c, f} of current waveform < 2 | |
| PCMAX_C_DIFFERENCE_06 | 2 ≤ P_{CMAX, c, f} of target waveform − | dB |
| | P_{CMAX, c, f} of current waveform < 3 | |
| PCMAX_C_DIFFERENCE_07 | 3 ≤ P_{CMAX, c, f} of target waveform − | dB |
| | P_{CMAX, c, f} of current waveform | |

The reported value range can be determined based on one or more of modulation order and waveform.

Regarding modulation order, the value range can be based on
the largest MPR among all modulation orders and RB allocations, or
MPR of a specific low modulation order, for example QPSK. The motivation is that when network device such as gNB is aware of the deterioration of the UE's radio link, which may be close to cell edge, it wouldn't schedule high modulation order for the UE.

Regarding waveform, the value range can be based on
MPR for CP-OFDM only or
This is under the assumption that a UE may require an actual power backoff lower than MPR for DFT-S-OFDM.
the difference between MPR of two waveforms
For example, for QPSK, the difference of MPR between two waveforms is 2 dB, so a reporting range of P_{CMAX,f,c} difference can be up to 2 dB.

FIG. 4a shows a flowchart of a method according to another embodiment of the present disclosure, which may be performed by an apparatus implemented in or at or as a terminal device or communicatively coupled to the terminal device. As such, the apparatus may provide means or modules or circuits for accomplishing various parts of the method 400 as well as means or modules or circuits for accomplishing other processes in conjunction with other components. For some parts which have been described in the above embodiments, the description thereof is omitted here for brevity.

At block 402, the terminal device may send the first PHR to the network device. The first PHR may comprise power headroom information of a waveform selected from the first waveform and the second waveform.

Which waveform is selected from the first waveform and the second waveform can be determined in various ways. For example, the target waveform may be firstly selected. The waveform selection may be determined based on a rule or a condition.

In an embodiment, a waveform selection may be based on at least one of the second waveform is selected if the most recent transmission used the first waveform; the first waveform is selected if the most recent transmission used the second waveform; a target waveform is selected; when a current waveform is CP-OFDM, if a power headroom of the current waveform is negative, the target waveform is selected; when the current waveform is CP-OFDM, if the power headroom of the current waveform is positive, the current waveform is selected; when a current waveform is Discrete Fourier Transform spread OFDM (DFT-S-OFDM), if a power headroom of the current waveform is positive, the target waveform is selected; if a power headroom of a most recent transmission is negative, DFT-S-OFDM is selected, otherwise CP-OFDM is selected; or when the current waveform is DFT-S-OFDM, if the power headroom of the current waveform is negative, the current waveform is selected.

At block 404, optionally, the terminal device may send a second PHR to the network device. The second PHR may comprise power headroom information for a remaining waveform from the first waveform and the second waveform. For example, if the first waveform is selected at block 402, then the remaining waveform is second waveform.

In an embodiment, if the terminal device receives Downlink Control Information (DCI) indicating waveform switching after a transmission of the first PHR and before a transmission of the second PHR, the transmission of the second PHR is canceled at block 404.

For example, the agreement in RAN #100 that “RAN2 will not work on PHR triggering procedure for dynamic waveform switching in Rel-18 UL Coverage enh WI” implies that the legacy PHR triggering events apply to the enhanced power headroom report of two waveforms, if supported. When a PHR triggering event occurs, it is to be decided whether a UE reports the information of two waveforms in one PHR MAC CE or in separate PHR MAC CEs and/or whether a UE can only report the information of one prioritized (or selected) waveform. These are illustrated in FIGS. 4b, 4c and 4d. A benefit of the latter two is that the legacy PHR MAC CE for one waveform can be reused as much as possible. However, a prioritization or selection rule is needed for the UE to select one waveform to report first or report only.

FIG. 4b shows an example of power headroom information of two waveforms (WFs) in one PHR according to an embodiment of the present disclosure. The terminal device may transmit PUSCH transmission with the first waveform (WF1). When the PHR of two waveforms is triggered, the terminal device may transmit PUSCH transmission with WF1, including PHR of two WFs.

FIG. 4c shows an example of power headroom information of two WFs in two PHRs according to an embodiment of the present disclosure. The terminal device may transmit PUSCH transmission with the first waveform (WF1). When the PHR of two waveforms is triggered, the terminal device may transmit PUSCH transmission with WF1, including PHR of the high-priority (or selected) WF. Then the terminal device may transmit PUSCH transmission with WF1, including PHR of the low-priority (or remaining) WF.

FIG. 4d shows an example of power headroom information of one prioritized WF according to an embodiment of the present disclosure. The terminal device may transmit PUSCH transmission with the first waveform (WF1). When the PHR of two waveforms is triggered, the terminal device may transmit PUSCH transmission with WF1, including PHR of the high-priority (or selected) WF.

Embodiment 3. If the power headroom information of two waveforms is triggered, a UE can select a waveform to report its associated power headroom information first or only. The waveform selection is based on some rules.
Option 1: Power headroom information of the target waveform is prioritized, namely, the waveform different from the current waveform. This is because the power information of the current waveform can somewhat be known by the network device such as gNB through power control, SRS.
Option 2: When the current waveform is CP-OFDM, if the power headroom of the current waveform is negative, namely smaller than 0 dB, a UE prioritizes PHR of the target waveform, otherwise, it prioritizes PHR of the current waveform. Similarly, when the current waveform is DFT-S-OFDM, if the power headroom of the current waveform is positive, namely larger than 0 dB, a UE prioritizes PHR of the target waveform; otherwise, it prioritizes PHR of the current waveform.

The purpose of Option 2 is to facilitate network device's decision on whether waveform switching should be triggered. Let's consider a UE reports the PHR of prioritized waveform only. PHR of the target waveform indicates the UE has an UL coverage issue with the current CP-OFDM or it has no coverage concern with the current DFT-S-OFDM and can be regarded as a suggestion of waveform switching. Meanwhile, PHR of the current waveform indicates it has no coverage issue with the current CP-OFDM or it has a coverage issue even with the current DFT-S-OFDM and can be regarded as a suggestion of keeping the current waveform.

In an alternative to Option 2, if power headroom of the current waveform is negative, a UE would report PHR of DFT-S-OFDM. Otherwise, a UE reports PHR of CP-OFDM.

A sub-embodiment of Embodiment 3, in the case of UE reporting power headroom information of two waveforms in two PHR MAC CEs, if a UE receives a DCI indicating waveform switching after the transmission of the first PHR MAC CE and before the transmission of the second PHR MAC CE, it cancels the transmission of the second PHR MAC CE.

FIG. 4e shows an example of cancellation of second PHR MAC CE according to an embodiment of the present disclosure. As illustrated in FIG. 4e, The terminal device may transmit PUSCH transmission with the first waveform (WF1). When the PHR of two waveforms is triggered, the terminal device may first transmit PUSCH transmission with WF1, including PHR of the second waveform (WF2). If the terminal device receives indication of waveform switching or receive an UL grant for WF2, it cancels the transmission of the second PHR MAC CE. The terminal device may transmit PUSCH transmission with the WF2.

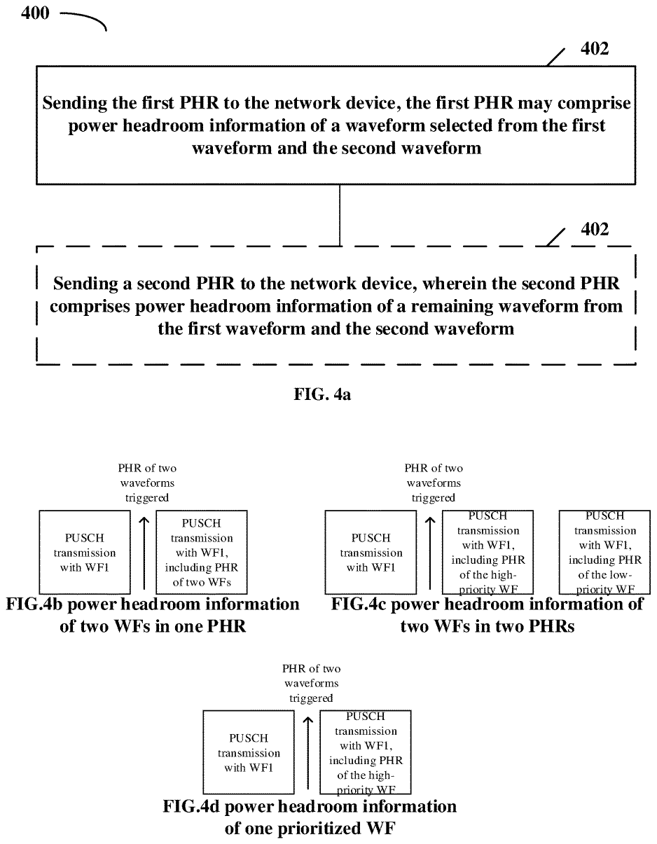

FIG. 5a shows a flowchart of a method according to another embodiment of the present disclosure, which may be performed by an apparatus implemented in or at or as a terminal device or communicatively coupled to the terminal device. As such, the apparatus may provide means or modules or circuits for accomplishing various parts of the method 500 as well as means or modules or circuits for accomplishing other processes in conjunction with other components. For some parts which have been described in the above embodiments, the description thereof is omitted here for brevity.

At block 502, the terminal device may start or restart a PHR periodic timer and/or a PHR prohibit timer based on at least one of upon receiving a Radio Resource Control (RRC) or DCI signaling indicating a waveform switching from the network node, upon a start or end of a first Physical Uplink Shared Channel (PUSCH) transmission with a new switched waveform, or upon RRC configuration or reconfiguration of dynamic waveform switching.

For example, the PHR periodic timer may specify the reporting periodicity for the UE's PHR transmissions. It may define the interval at which the UE should send PHR reports to the network node. The value of PHR periodic timer may determine the duration between consecutive PHR reports. In an embodiment, the PHR periodic timer may be same or similar as/to phr-PeriodicTimer as described in 3GPP TS 38.321 V17.5.0.

For example, the PHR prohibit timer may specify a duration during which the UE is prohibited from sending PHR reports after a specific event. It helps to prevent excessive reporting when certain events occur in quick succession. The PHR prohibit timer may ensure a controlled and efficient reporting mechanism. In an embodiment, the PHR prohibit timer may be same or similar as/to phr-ProhibitTimer as described in 3GPP TS 38.321 V17.5.0.

In NR up to 3GPP Release 17, if the Power Headroom reporting procedure determines that at least one PHR has been triggered and not cancelled, a UE would start or restart phr-PeriodicTimer and start or restart phr-ProhibitTimer. This can be improved by considering waveform switching.

Embodiment 4, a UE would start or restart phr-PeriodicTimer and/or phr-ProhibitTimer upon one or more of the following situations:
Upon receiving a RRC or DCI signaling indicating a waveform switching,
Upon the start/end of the first PUSCH transmission with the newly switched waveform, or
Upon RRC configuration or reconfiguration of dynamic waveform switching, which enables/disables dynamic waveform switching.

In an embodiment, a first part of an octet in a first PHR MAC CE may indicate the power headroom for the second waveform and a second part of the octet indicates the power headroom for the first waveform.

The first PHR MAC CE may be any suitable PHR MAC CE such as existing or new PHR MAC CE. In an embodiment, the first PHR MAC CE may comprise a Single Entry PHR MAC CE as described in 3GPP TS38.321 V17.5.0.

The first part may comprise any suitable bits. The second part may comprise any suitable bits. For example, the first part may comprise 3bits and the second part may comprise 3bits. The first part may comprise N bits and the second part may comprise 6-N bits, where N may be any suitable integer such as 1, 2, 3, 4, 5.

In an embodiment, a third part of an octet in the first PHR MAC CE may indicate the terminal device configured maximum output power for the second waveform and a fourth part of the octet in the first PHR MAC CE may indicate the terminal device configured maximum output power for the first waveform.

The third part may comprise any suitable bits. The fourth part may comprise any suitable bits. For example, the third part may comprise 3bits and the fourth part may comprise 3bits. The third part may comprise N bits and the fourth part may comprise 6-N bits, where N may be any suitable integer such as 1, 2, 3, 4, 5.

In an embodiment, the first part of the octet may comprise three bits. The second part of the octet may comprise three bits.

In an embodiment, the fourth part of the octet may comprise three bits. The third part of the octet may comprise three bits.

In an embodiment, a number of existing power headroom values may be reduced based on a length of the first part and/or a length the second part. The existing power headroom values may be those as described in various 3GPP specifications such as 3GPP TS 38.133 V17.8.0. For example, if the number of existing power headroom values is 64 and the length of the first part is 3bits, the number of existing power headroom values may be reduced to 8.

In an embodiment, a number of existing terminal device configured maximum output power values may be reduced based on a length of the third part and/or a length the fourth part. The existing terminal device configured maximum output power values may be those as described in various 3GPP specifications such as 3GPP TS 38.133 V17.8.0. For example, if the number of existing terminal device configured maximum output power values is 64 and the length of the third part is 3bits, the number of existing terminal device configured maximum output power values may be reduced to 8.

In an embodiment, one of every several consecutive existing power headroom values may be selected. The selected one may be used as a power headroom value which can be indicated using the first part or the second part. For example, if the number of existing power headroom values is 64 and the number of existing power headroom values is reduced to 8, one of every 8 consecutive existing power headroom values may be selected. The selected one may be any one of every 8 consecutive existing power headroom values, such as the first one, the second one, the third one, the fourth one, the fifth one, the sixth one, the seventh one, or the eighth one.

In an embodiment, one of every several consecutive existing terminal device configured maximum output power values may be selected. The selected one may be used as a terminal device configured maximum output power value which can be indicated using the third part or the fourth part. For example, if the number of existing terminal device configured maximum output power values is 64 and the number of existing terminal device configured maximum output power values is reduced to 8, one of every 8 consecutive existing terminal device configured maximum output power values may be selected. The selected one may be any one of 8 consecutive existing terminal device configured maximum output power values, such as the first one, the second one, the third one, the fourth one, the fifth one, the sixth one, the seventh one, or the eighth one.

In an embodiment, every several consecutive existing power headroom values may be combined. The combined one may be used as a power headroom value which can be indicated using the first part or the second part.

In an embodiment, every several consecutive existing terminal device configured maximum output power values may be combined. The combined one may be used as a terminal device configured maximum output power value which can be indicated using the third part or the fourth part.

In an embodiment, which one from each of several consecutive existing power headroom values is selected may be predetermined.

In an embodiment, which one from each of several consecutive existing terminal device configured maximum output power values may be selected is predetermined.

For example, for PHR MAC CE, payload is not a concern. On the other hand, cases like SPS/configured grant can be more sensitive, since payload sizes are fixed and may be small. Thus, when a PHR with increased size is intermittently added, there can be more impact. So repurposing and/or using reserved bits might be quite reasonable.

The legacy single Entry PHR MAC CE, which has a fixed size and consists of two octets. The reported P_{CMAX,f,c} and the corresponding nominal UE transmit power levels are shown in Table 6.1.3.8-2 (the corresponding measured values in dBm are specified in 3GPP TS 38.133 V17.8.0). These can be a starting point for a method that reports the 3-bit new information for the target waveform discussed in embodiment 2 above.

Embodiment 5, one or more LSB(s)/MSB(s) of a legacy field can be repurposed to indicate the information related to the target waveform. How to interpret the information of the target waveform from these bits can be newly defined, such as in Table 1 and Table 2. The remaining LSB(s)/MSB(s) of the field are still used for the legacy purpose. How to indicate the legacy field with fewer bits can be done with one or more of the following options.
Option 1, reducing the number of reported values, so that fewer rows can be indicated with fewer bits.

In one alternative, one out of every several consecutive rows in Table 6.1.3.8-2 or Table 10.1.18.1-1 can be selected, and a UE selects and reports a row, where its measured value is within or closest to the corresponding value range of the row. Which specific one out of every several consecutive rows, for example the first one or the medium one, can be predetermined. For example, the first of every consecutive eight rows, namely 1st, 9th, 17th, . . . , 57th rows, are selected.

In another alternative, value range of several consecutive rows are combined. For example, if the first three rows of Table 10.1.18.1-1 are combined as one reported value, its value range is P_{CMAX,c,f}<−27.
Option 2, with some calculation based on L, the legacy bit width of the PH or P_{CMAX,c,f} field, and R, the remaining number of bits for the legacy interpretation, e.g., the decimal value of R

$$bits = ⌊ \frac{the decimal value of L bits}{{2}^{( L - R )}} ⌋ .$$

With this calculation, the legacy consecutive 2^{(L-R)} reported values are represented by one value of R bits. How network device such as gNB interprets the one value can be up to network device such as gNB implementation or predetermined, such as the first or the medium value of the corresponding 2^{(L-R)} reported values in legacy tables.

In an sub-embodiment, the smallest legacy reported value and the largest legacy one are among those to be reported after repurposing. Since the first and the last row, e.g., in Table 10.1.18.1-1, indicate a wider range than the granularity of other rows, their corresponding reported value can deliver more information than others. With Option 1, this means the two reported values are always selected or not combined with other rows. With Option 2, the smallest legacy reported value and the largest legacy one are represented as all 0 and all 1.

In another sub-embodiment, since a field is repurposed for indication of information of two waveforms, it can be predetermined that which waveform between CP-OFDM and DFT-S-OFDM or between current waveform and target waveform the one or more MSBs are related to. For example, the MSB(s) and LSB(s) are related to CP-OFDM and DFT-S-OFDM respectively. Or the MSB(s) and LSB(s) are related to current waveform and target waveform respectively.

In an embodiment, the third and fourth parts of the octet may indicate a first and a second power difference, Pₘₐₓ₁−P and Pₘₐₓ₂−P, respectively. Pₘₐₓ₁ may be the terminal device configured maximum output power for the first waveform. Pₘₐₓ₂ may be the terminal device configured maximum output power for the second waveform. P may be a predetermined power value. P may be at least one of a power corresponding to a power class of the terminal device, and a power level configured to the terminal device for the purpose of determining the first PHR.

FIG. 5b shows a flowchart of a method according to another embodiment of the present disclosure, which may be performed by an apparatus implemented in or at or as a terminal device or communicatively coupled to the terminal device. As such, the apparatus may provide means or modules or circuits for accomplishing various parts of the method 510 as well as means or modules or circuits for accomplishing other processes in conjunction with other components. For some parts which have been described in the above embodiments, the description thereof is omitted here for brevity.

At block 512, the terminal device may compare the first power difference Pₘₐₓ₁−P to a series of lower and upper values, thereby producing a first quantized value carried in the third part of the octet.

At block 514, the terminal device may compare the second power difference Pₘₐₓ₂−P to the series of lower and upper values, thereby producing a second quantized value carried in the fourth part of the octet.

Embodiment 5A: Similar to embodiment 5, the 6 bit field size of P_{CMAX,c,f} in 3GPP Release 18 is reduced to 6-N bits, and N bits are used to indicate the difference in power required for DFT-S-OFDM vs CP-OFDM.

It can be observed that P_{CMAX,c,f} has more than 60 dB of range in the values it can report (from −29 dBm to 33 dBm). The high end of this range supports the highest power class for FR1 (which has 31 dBm and +2 dB tolerance, and so can transmit up to 33 dBm), while the low end allows for more than 50 dB of power reduction below FR1 power class 3 power of 23 dBm (since the minimum reportable P_{CMAX,c,f} of −29 dBm is 52 dB below 23 dBm). The highest end values will not be reported for lower power class UEs: for example a power class 3 UE should not report more than 25 dBm, taking into account 2 dB tolerance. Furthermore, very high values of power reduction are not expected in normal operation, and the network does not necessarily benefit from knowing such a large value of power reduction with high accuracy. The network will not likely be able to easily compensate for very high power reduction, and will either avoid scheduling the UE, hand over the UE to another cell or carrier, etc., rather than trying to serve the UE on the resources for which it has such high power reduction. Moreover, since P_{CMAX,c,f} is nominally equal to the power of the power class of the UE, and power reduction is according to the power class of the UE, the difference from the power class power of the UE would better quantize P_{CMAX,c,f} than the broad range of power values in 3GPP Release 18 (i.e. those in Table 10.1.18-1.1 above).

An embodiment allowing a smaller bit field to report P_{CMAX,c,f} can then consist of quantizing values of P_{CMAX,c,f}−Pₓ, where Pₓ is a value in dBm. In some embodiments, Pₓ is the nominal power of the power class of the UE. In more general embodiments, Pₓ is configured to the UE as part of the configuration of the PHR reporting that supports waveform switching. The more general embodiment can be useful where a nominal power reduction is generally expected (for example, where the network will tend to schedule the UE with modulation orders, or in PRBs, where non-zero MPR is expected). The more general embodiment may also be useful where power class fallback is likely, such that the UE will tend to transmit with a lower power class than its nominal power class.

Table 3 below describes an example quantization scheme, where the difference, P_{CMAX,c,f}−Pₓ, is tested against lower and/or upper values and the index of the row that meets the test is reported. More general embodiments include where there are more quantization states, i.e. rows in the table, where the differences between the low and high values in each row are other than 1 dB, and/or where different choices for the low and high values are made.

TABLE 3
P_{CMAX, c, f} difference quantization method

| Reported value | Power difference range | Unit |
|---|---|---|
| Px_DIFFERENCE_00 | 1 =< P_{CMAX, c, f} − Pₓ < 2 | dB |
| Px_DIFFERENCE_01 | 0 =< P_{CMAX, c, f} − Pₓ < 1 | dB |
| Px_DIFFERENCE_02 | −1 =< P_{CMAX, c, f} − Pₓ < 0 | dB |
| . . . | | . . . |
| Px_DIFFERENCE_06 | −5 =< P_{CMAX, c, f} − Pₓ < −4 | dB |
| Px_DIFFERENCE_07 | P_{CMAX, c, f} − Pₓ < −5 | dB |

In an embodiment, the power difference quantization method Table 3 is used to report P_{CMAX,c,f} for one waveform, and the difference between P_{CMAX,f,c} of the two waveforms from embodiment 2 in either Table 1 or Table 2 captures the difference in power if either waveform is used.

FIG. 5c shows an example of how an example power headroom report can be structured using quantities according to an embodiment of the present disclosure. Modified Single Entry PHR MAC CE using Power Difference Reporting for P_{CMAX,c,f} is as an example. The power difference report for P_{CMAX,c,f}, shown as P′_{CMAX,c,f} is reported with 3 bits, while the difference between P_{CMAX,f,c} of the two waveforms, shown as ΔP_{waveform}, is also reported with 3 bits, and a power headroom value, labeled ‘PH (Type 1, PCell)’, occupies 6 bits. The value of P′_{CMAX,c,f} and the power headroom ‘PH’ both corresponds to a same waveform, while the value of ΔP_{waveform} corresponds to the difference in power between the same waveform and a different waveform. In some embodiments, the Release 18 3GPP NR power headroom determination method is used to determine the value of PH.

In an alternative embodiment, the power difference quantization method Table 3 is used to report P_{CMAX,c,f} for a first and a second waveform, and the power headroom available for one of the two waveforms is reported. In this case, the amount of power control does not change between the two waveforms, and so the difference in power headroom for the two waveforms can be computed as the difference in the reported values of P_{CMAX,c,f} for the first and second waveforms. For example, if the available power for the first and second waveforms conveyed in a report are identified as P′_{CMAX,c,f} and P″_{CMAX,c,f}, respectively, then the power headroom for the second waveform, PH′, can be computed as PH′=PH+P″_{CMAX,c,f}−P′_{CMAX,c,f}, where PH is the power headroom provided for the first waveform in the report.

FIG. 5d shows an example of how an example power headroom report can be structured using power difference quantized values for the two waveforms according to an embodiment of the present disclosure. Modified Single Entry PHR MAC CE uing Alternative Power Difference Reporting for P_{CMAX,c,f} is used an example. The power difference reports for P_{CMAX,c,f}, the first and second waveforms shown as P′_{CMAX,c,f} and P″_{CMAX,c,f}, respectively, are reported with 3 bits each, and a power headroom value, labeled ‘PH (Type 1, PCell)’, occupies 6 bits. The value of P′_{CMAX,c,f} and the power headroom ‘PH’ both correspond to the first waveform, while the value of P″_{CMAX,c,f} corresponds to the power of the second waveform. In some embodiments, the Release 18 3GPP NR power headroom determination method is used to determine the value of PH.

In an embodiment, a UE reports a maximum amount of power available for transmission, Pₘₐₓ, according to a difference from a predetermined power value, P, where the value P is at least one of a power corresponding to a power class of the UE and a power level configured to the UE for the purpose of power headroom reporting. The UE compares the quantity Pₘₐₓ−P to a series of lower and upper values, and produces a quantized value of the quantity Pₘₐₓ−P. The UE provides the quantized value of Pₘₐₓ−P in a power headroom report. In some embodiments, the UE produces a first quantized value if Pₘₐₓ−P is greater than or equal to a first lower value of the lower values and if Pₘₐₓ−P is less than a first upper value of the upper values, while the UE produces a second quantized value if Pₘₐₓ−P is greater than or equal to a second lower value of the lower values and if Pₘₐₓ−P is less than a second upper value of the upper values.

In an embodiment, the quantized value of Pₘₐₓ−P is used to identify the amount of power available according to if one of a plurality of waveforms is used for transmission. The UE reports both the quantized value of Pₘₐₓ−P and an indication of power difference between the two waveforms. The quantized value of Pₘₐₓ−P identifies the power available according to when a first waveform of the plurality of waveforms is used for transmission, while the indication of the power difference identifies the additional amount of power available if a second waveform of the plurality of waveforms is used for transmission instead of the first waveform. The UE also determines a power headroom available according to if a predetermined one of the first or second waveform is used for transmission. The UE includes the indications of the power headroom and the power difference between the two waveforms together with the quantized value of Pₘₐₓ−P in the power headroom report.

In an embodiment, a first and a second quantized value of Pₘₐₓ−P are used to identify the amount of power available according to one of a first and a second transmission condition, such as the first or second waveform is used for transmission. The UE also determines a power headroom available according to a predetermined one of the first and second transmission condition. The UE includes the indications of the power headroom and the second Pₘₐₓ together with the quantized value of Pₘₐₓ−P in the power headroom report.

In an embodiment, a compact reporting method for P_{CMAX,c,f} could be useful for more than where the UE switches among waveforms. For example, the UE may have different values of P_{CMAX,c,f} when it transits on different carriers, or when it transmits PUSCH, SRS, or Physical Uplink Control Channel (PUCCH). Therefore, in some embodiments, a first and a second transmission condition correspond to at least one of transmitting with a first and a second waveform, respectively, transmitting on a first and a second carrier, respectively, and transmitting a first and a second physical channel or physical signal, respectively.

In an embodiment, if an actual PUSCH is multi-layer PUSCH with CP-OFDM, a capability of the terminal device reporting power headroom information of a target waveform may be indicated by at least one of reporting power headroom information of the target waveform for multi-layer PUSCH and for single-layer PUSCH are separate terminal device capabilities, a capability of PHR of the target waveform is release independent. If the terminal device indicates such capability and it supports multi-layer PUSCH with DFT-S-OFDM, the terminal device can support PHR of target waveform transmitted in a multi-layer PUSCH.

For example, P_{CMAX,f,c} depends on not only waveform but also modulation order, which is related to rank. A simply way of reporting P_{CMAX,f,c} of the target waveform is based on modulation order of the actual PUSCH. A restriction up to NR Release 18 is that DFT-S-OFDM is limited to single-layer PUSCH transmission. Therefore, if the actual PUSCH transmission is 2-layer with CP-OFDM, a UE can't report power headroom information of DFT-S-OFDM, because 2-layer PUSCH with DFT-S-OFDM is not supported. A question is if multi-layer PUSCH with DFT-S-OFDM is supported as a new UE capability in the future release, how can the PHR of target waveform be forward compatible and updated with the new UE capability.

Embodiment 6, if the actual PUSCH is multi-layer PUSCH with CP-OFDM, the capability of UE reporting power headroom information of target waveform is indicated by one or more of the following ways. Reporting power headroom information of target waveform for multi-layer PUSCH and for single-layer PUSCH are separate UE capabilities. The capability of PHR of target waveform is release independent. If a UE indicates such capability and it supports multi-layer PUSCH with DFT-S-OFDM, it can support PHR of target waveform transmitted in a multi-layer PUSCH.

FIG. 5e shows a flowchart of a method according to another embodiment of the present disclosure, which may be performed by an apparatus implemented in or at or as a terminal device or communicatively coupled to the terminal device. As such, the apparatus may provide means or modules or circuits for accomplishing various parts of the method 520 as well as means or modules or circuits for accomplishing other processes in conjunction with other components. For some parts which have been described in the above embodiments, the description thereof is omitted here for brevity.

At block 522, the terminal device may receive a signaling indicating a waveform switching from the network device. The signaling may be any suitable signaling such as RRC signaling, DCI signaling, MAC CE signaling, or implicit signaling for example as described in R1-2109024.

In an embodiment, the waveform switching may be determined based on the first PHR and/or the second PHR.

When the terminal device may receive the signaling indicating the waveform switching from the network device, the terminal device may transmit UL (such as PUSCH) transmission with the waveform according to the signaling indicating.

FIG. 6 shows a flowchart of a method according to another embodiment of the present disclosure, which may be performed by an apparatus implemented in or at or as a network device or communicatively coupled to the network device. As such, the apparatus may provide means or modules or circuits for accomplishing various parts of the method 600 as well as means or modules or circuits for accomplishing other processes in conjunction with other components. For some parts which have been described in the above embodiments, the description thereof is omitted here for brevity.

At block 602, the network device may receive a first power headroom report (PHR) from a terminal device. For example, the terminal device may send the first PHR at block 302 of FIG. 3a, then the network device may receive the PHR from the terminal device.

In an embodiment, the first PHR may comprise first power headroom information for a first waveform and/or second power headroom information for a second waveform.

In an embodiment, the first power headroom information for the first waveform may comprise information about first terminal device configured maximum output power and/or information about first power headroom, and/or

In an embodiment, the second power headroom information for the second waveform may comprise information about second terminal device configured maximum output power and/or information about second power headroom.

In an embodiment, the first PHR may comprise the information about the first terminal device configured maximum output power, the information about the second terminal device configured maximum output power and one of the information about the first power headroom and the information about the second power headroom.

In an embodiment, the first PHR may comprise the information about the first power headroom, the information about the second power headroom and one of the information about the first terminal device configured maximum output power and the information about the second terminal device configured maximum output power.

In an embodiment, the first PHR may comprise first waveform indication information associated with the information about the first power headroom information and/or second waveform indication information associated with the information about the second power headroom information.

In an embodiment, the first waveform indication information and/or the second waveform indication information may be indicated by at least one of a bit of a new field in a PHR medium access control (MAC) control element (CE), a bit of an existing field in a PHR MAC CE, or a predefined rule.

In an embodiment, the predefined rule may comprise at least one of the second power headroom information may be appended after the first power headroom information, the information about second terminal device configured maximum output power for the second waveform may be appended after the information about the first terminal device configured maximum output power, or the information about the second power headroom for the second waveform may be appended after the information about the first power headroom for the first waveform.

In an embodiment, the existing field in the PHR MAC CE may comprise a reserved field.

In an embodiment, the information about the second terminal device configured maximum output power or the information about the second power headroom for the second waveform may be appended after an existing PHR MAC CE format for multiple transmission reception point. The existing PHR MAC CE format may comprise the first terminal device configured maximum output power and the first power headroom for the first waveform.

In an embodiment, the information about the first terminal device configured maximum output power for the first waveform may comprise information indicating the first terminal device configured maximum output power, or information indicating a first difference of the first terminal device configured maximum output power and a first power value and the information about the second terminal device configured maximum output power for the second waveform may comprise information indicating the second terminal device configured maximum output power, or information indicating a second difference of the first terminal device configured maximum output power and the second terminal device configured maximum output power, or information indicating a third difference of the second terminal device configured maximum output power and the first power value.

In an embodiment, the information about the first power headroom for the first waveform may comprise information indicating the first power headroom, or information indicating a fourth difference of the first power headroom and a second power value and the information about the second power headroom for the second waveform may comprise information indicating the second power headroom, or information indicating a fifth difference of the first power headroom and the second power headroom, or information indicating a sixth difference of the second power headroom and the second power value.

In an embodiment, the first power value and/or the second power value may comprise at least one of a nominal power of a power class of the terminal device, a configured value, or a predetermined value.

In an embodiment, the first PHR may comprise power headroom information of a waveform selected from the first waveform and the second waveform.

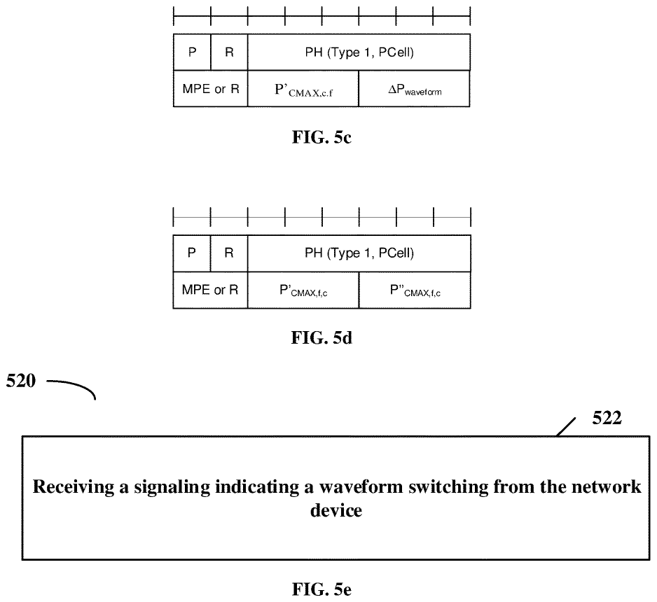

FIG. 7a shows a flowchart of a method according to another embodiment of the present disclosure, which may be performed by an apparatus implemented in or at or as a network device or communicatively coupled to the network device. As such, the apparatus may provide means or modules or circuits for accomplishing various parts of the method 700 as well as means or modules or circuits for accomplishing other processes in conjunction with other components. For some parts which have been described in the above embodiments, the description thereof is omitted here for brevity.

At block 702, the network device may receive a second PHR from the terminal device. The second PHR may comprise power headroom information for a remaining waveform from the first waveform and the second waveform.

FIG. 7b shows a flowchart of a method according to another embodiment of the present disclosure, which may be performed by an apparatus implemented in or at or as a network device or communicatively coupled to the network device. As such, the apparatus may provide means or modules or circuits for accomplishing various parts of the method 710 as well as means or modules or circuits for accomplishing other processes in conjunction with other components. For some parts which have been described in the above embodiments, the description thereof is omitted here for brevity.

At block 712, the network device may determine a waveform switching based on the first PHR and/or the second PHR. The network device may determine the waveform switching based on the first PHR and/or the second PHR in various ways. For example, the network device may determine the waveform switching based on the first PHR and/or the second PHR in order to improve the UE's UL coverage or for other suitable purposes.

At block 714, the network device may send a signaling indicating a waveform switching to the terminal device. The signaling may be any suitable signaling such as RRC signaling, DCI signaling, MAC CE signaling, or implicit signaling for example as described in R1-2109024.

In an embodiment, a first part of an octet in a first PHR MAC CE may indicate the power headroom for the second waveform and a second part of the octet may indicate the power headroom for the first waveform.

In an embodiment, a third part of an octet in the first PHR MAC CE may indicate the terminal device configured maximum output power for the second waveform and a fourth part of the octet in the first PHR MAC CE may indicate the terminal device configured maximum output power for the first waveform.

In an embodiment, the first PHR MAC CE may comprise a Single Entry PHR MAC CE.

In an embodiment, the first part of the octet may comprise three bits.

In an embodiment, the fourth part of the octet may comprise three bits.

In an embodiment, the third and fourth parts of the octet may indicate a first and a second power difference, Pₘₐₓ₁−P and Pₘₐₓ₂−P, respectively. Pₘₐₓ₁ may be the terminal device configured maximum output power for the first waveform. Pₘₐₓ₂ may be the terminal device configured maximum output power for the second waveform. P may be a predetermined power value that is at least one of a power corresponding to a power class of the terminal device and a power level configured to the terminal device for the purpose of determining the first PHR.

In an embodiment, the first power difference Pₘₐₓ₁−P to a series of lower and upper values may be compared to produce a first quantized value carried in the third part of the octet.

In an embodiment, the second power difference Pₘₐₓ₂−P to the series of lower and upper values may be compared to produce a second quantized value carried in the fourth part of the octet.

In an embodiment, a number of existing power headroom values may be reduced based on a length of the first part and/or a length the second part.

In an embodiment, a number of existing terminal device configured maximum output power values may be reduced based on a length of the third part and/or a length the fourth part.

In an embodiment, one of every several consecutive existing power headroom values may be selected.

In an embodiment, one of every several consecutive existing terminal device configured maximum output power values may be selected.

In an embodiment, every several consecutive existing power headroom values may be combined.

In an embodiment, every several consecutive existing terminal device configured maximum output power values may be combined.

In an embodiment, which one from each of several consecutive existing power headroom values is selected may be predetermined.

In an embodiment, which one from each of several consecutive existing terminal device configured maximum output power values is selected may be predetermined.

In an embodiment, if an actual PUSCH is multi-layer PUSCH with CP-OFDM, a capability of the terminal device reporting power headroom information of a target waveform may be indicated by at least one of reporting power headroom information of the target waveform for multi-layer PUSCH and for single-layer PUSCH are separate terminal device capabilities, a capability of PHR of the target waveform is release independent. If the terminal device indicates such capability and it supports multi-layer PUSCH with DFT-S-OFDM, the terminal device can support PHR of target waveform transmitted in a multi-layer PUSCH.

In an embodiment, the first waveform may be CP-OFDM and the second waveform may be DFT-S-OFDM.

In an embodiment, the first waveform is DFT-S-OFDM and the second waveform is CP-OFDM.

In an embodiment, the first waveform is a current waveform and the second waveform is a target waveform.

In an embodiment, the first waveform is a target waveform and the second waveform is a current waveform.

Embodiments herein may provide many advantages, of which a non-exhaustive list of examples follows. In some embodiments herein, it enables a terminal device to report the power headroom information for a target waveform. In some embodiments herein, it enables the terminal device to select a waveform from two waveforms, for which the UE reports its PHR first or only. In some embodiments herein, it enables the terminal device to know when to start or restart phr-PeriodicTimer and/or phr-ProhibitTimer. In some embodiments herein, the legacy PHR MAC CE for a waveform can be reused as much as possible. In some embodiments herein, a legacy field can be repurposed to indicate the power information related to the two waveforms. In some embodiments herein, the power difference quantization method is used to report power information for a waveform, which can enable fewer bits to be occupied. In some embodiments herein, it enables the terminal device to report power headroom information of two waveforms in a PHR MAC CE. In some embodiments herein, it enables the terminal device to report power headroom information of two waveforms in separate PHR MAC CEs. The embodiments herein are not limited to the features and advantages mentioned above. A person skilled in the art will recognize additional features and advantages upon reading the following detailed description.

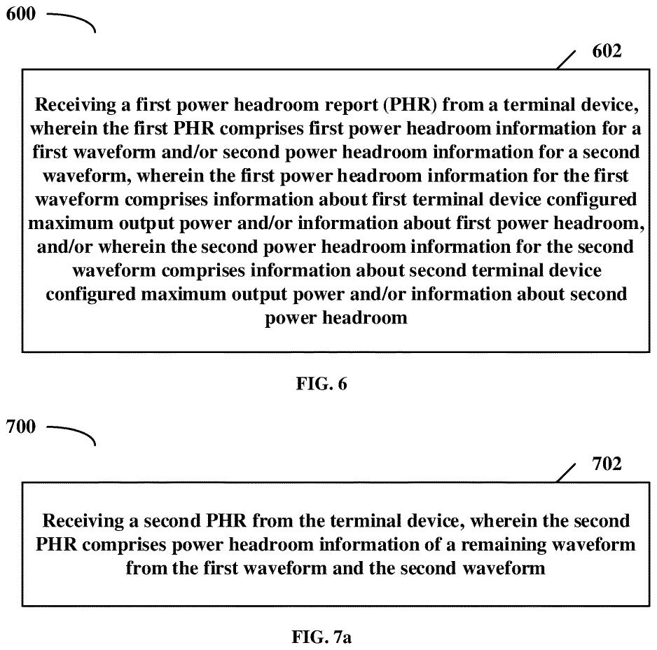

FIG. 8a is a block diagram showing an apparatus suitable for practicing some embodiments of the disclosure. For example, the terminal device or the network device described above may be implemented as or through the apparatus 800.

The apparatus 800 comprises at least one processor 821, such as a digital processor (DP), and at least one memory (MEM) 822 coupled to the processor 821. The apparatus 800 may further comprise a transmitter TX and receiver RX 823 coupled to the processor 821. The MEM 822 stores a program (PROG) 824. The PROG 824 may include instructions that, when executed on the associated processor 821, enable the apparatus 800 to operate in accordance with the embodiments of the present disclosure. A combination of the at least one processor 821 and the at least one MEM 822 may form processing means 825 adapted to implement various embodiments of the present disclosure.

Various embodiments of the present disclosure may be implemented by computer program executable by one or more of the processor 821, software, firmware, hardware or in a combination thereof.

The MEM 822 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 821 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the terminal device, the memory 822 contains instructions executable by the processor 821, whereby the terminal device operates according to any of the methods related to the terminal device as described above.

In an embodiment where the apparatus is implemented as or at the network device, the memory 822 contains instructions executable by the processor 821, whereby the network device operates according to any of the methods related to the network device as described above.

FIG. 8b is a block diagram showing a terminal device according to an embodiment of the disclosure. As shown, the terminal device 830 may comprise a first sending module 831 configured to send a first power headroom report (PHR) to a network device.

In an embodiment, the first PHR may comprise first power headroom information for a first waveform and/or second power headroom information for a second waveform.

In an embodiment, the first power headroom information for the first waveform may comprise information about first terminal device configured maximum output power and/or information about first power headroom.

In an embodiment, the second power headroom information for the second waveform may comprise information about second terminal device configured maximum output power and/or information about second power headroom.

In an embodiment, the terminal device 830 may further comprise a second sending module 832 configured to send a second PHR to the network device. The second PHR may comprise power headroom information for a remaining waveform from the first waveform and the second waveform.

In an embodiment, the terminal device 830 may further comprise a receiving module 833 configured to receive a signaling indicating a waveform switching from the network device.

In an embodiment, the terminal device 830 may further comprise a first comparing module 834 configured to compare the first power difference Pₘₐₓ₁−P to a series of lower and upper values, thereby producing a first quantized value carried in the third part of the octet.

In an embodiment, the terminal device 830 may further comprise a second comparing module 835 configured to compare the second power difference Pₘₐₓ₂−P to the series of lower and upper values, thereby producing a second quantized value carried in the fourth part of the octet.

In an embodiment, the terminal device 830 may further comprise a starting module 836 configured to start or restart a PHR periodic timer and/or a PHR prohibit timer based on at least one of upon receiving a Radio Resource Control (RRC) or DCI signaling indicating a waveform switching from the network node, upon a start or end of a first Physical Uplink Shared Channel (PUSCH) transmission with a new switched waveform, or—upon RRC configuration or reconfiguration of dynamic waveform switching.

FIG. 8c is a block diagram showing a network device according to an embodiment of the disclosure. As shown, the network device 840 may comprise a first receiving module 841 configured to receive a first power headroom report (PHR) from a terminal device.

In an embodiment, the first PHR may comprise first power headroom information for a first waveform and/or second power headroom information for a second waveform.

In an embodiment, the first power headroom information for the first waveform may comprise information about first terminal device configured maximum output power and/or information about first power headroom.

In an embodiment, the second power headroom information for the second waveform may comprise information about second terminal device configured maximum output power and/or information about second power headroom.

In an embodiment, the network device 840 may further comprise a second receiving module 842 configured to receive a second PHR from the terminal device. The second PHR may comprise power headroom information for a remaining waveform from the first waveform and the second waveform.

In an embodiment, the network device 840 may further comprise a determining module 843 configured to determine a waveform switching based on the first PHR and/or the second PHR.

In an embodiment, the network device 840 may further comprise a sending module 844 configured to send a signaling indicating a waveform switching to the terminal device.

With function units, the terminal device or the network device may not need a fixed processor or memory, any computing resource and storage resource may be arranged from the terminal device or the network device in the communication system. The introduction of virtualization technology and network computing technology may improve the usage efficiency of the network resources and the flexibility of the network.

Further, the exemplary overall commutation system including the terminal device and the network device will be introduced as below.

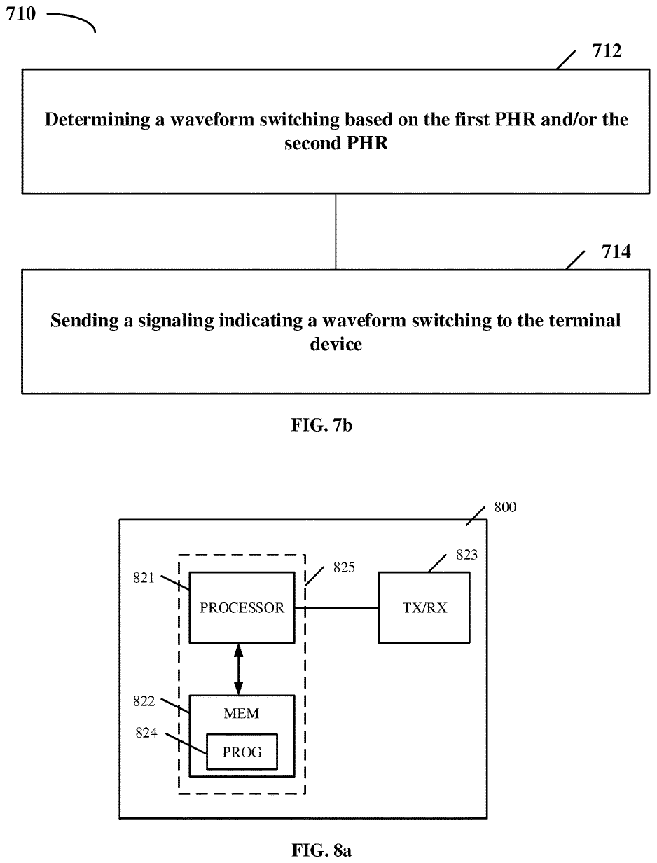

FIG. 9 shows an example of a communication system 9100 in accordance with some embodiments.

In the example, the communication system 9100 includes a telecommunication network 9102 that includes an access network 9104, such as a radio access network (RAN), and a core network 9106, which includes one or more core network nodes 9108. The access network 9104 includes one or more access network nodes, such as network nodes 9110a and 9110b (one or more of which may be generally referred to as network nodes 9110), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 9102 includes one or more Open-RAN (ORAN) network nodes. An ORAN network node is a node in the telecommunication network 9102 that supports an ORAN specification (e.g., a specification published by the O-RAN Alliance, or any similar organization) and may operate alone or together with other nodes to implement one or more functionalities of any node in the telecommunication network 9102, including one or more network nodes 9110 and/or core network nodes 9108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application or a non-real time control application, or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 9110 facilitate direct or indirect connection of user equipment (UE), such as by connecting UEs 9112a, 9112b, 9112c, and 9112d (one or more of which may be generally referred to as UEs 9112) to the core network 9106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 9100 may include any number of wired or wireless networks, network nodes, UEs, and/or any other components or systems that may facilitate or participate in the communication of data and/or signals whether via wired or wireless connections. The communication system 9100 may include and/or interface with any type of communication, telecommunication, data, cellular, radio network, and/or other similar type of system.

The UEs 9112 may be any of a wide variety of communication devices, including wireless devices arranged, configured, and/or operable to communicate wirelessly with the network nodes 9110 and other communication devices. Similarly, the network nodes 9110 are arranged, capable, configured, and/or operable to communicate directly or indirectly with the UEs 9112 and/or with other network nodes or equipment in the telecommunication network 9102 to enable and/or provide network access, such as wireless network access, and/or to perform other functions, such as administration in the telecommunication network 9102.

In the depicted example, the core network 9106 connects the network nodes 9110 to one or more hosts, such as host 9116. These connections may be direct or indirect via one or more intermediary networks or devices. In other examples, network nodes may be directly coupled to hosts. The core network 9106 includes one more core network nodes (e.g., core network node 9108) that are structured with hardware and software components. Features of these components may be substantially similar to those described with respect to the UEs, network nodes, and/or hosts, such that the descriptions thereof are generally applicable to the corresponding components of the core network node 9108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 9116 may be under the ownership or control of a service provider other than an operator or provider of the access network 9104 and/or the telecommunication network 9102, and may be operated by the service provider or on behalf of the service provider. The host 9116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 9100 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 9102 is a cellular network that implements 3GPP standardized features. Accordingly, the telecommunications network 9102 may support network slicing to provide different logical networks to different devices that are connected to the telecommunication network 9102. For example, the telecommunications network 9102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 9112 are configured to transmit and/or receive information without direct human interaction. For instance, a UE may be designed to transmit information to the access network 9104 on a predetermined schedule, when triggered by an internal or external event, or in response to requests from the access network 9104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 9114 communicates with the access network 9104 to facilitate indirect communication between one or more UEs (e.g., UE 9112c and/or 9112d) and network nodes (e.g., network node 9110b). In some examples, the hub 9114 may be a controller, router, content source and analytics, or any of the other communication devices described herein regarding UEs. For example, the hub 9114 may be a broadband router enabling access to the core network 9106 for the UEs. As another example, the hub 9114 may be a controller that sends commands or instructions to one or more actuators in the UEs. Commands or instructions may be received from the UEs, network nodes 9110, or by executable code, script, process, or other instructions in the hub 9114. As another example, the hub 9114 may be a data collector that acts as temporary storage for UE data and, in some embodiments, may perform analysis or other processing of the data. As another example, the hub 9114 may be a content source. For example, for a UE that is a VR headset, display, loudspeaker or other media delivery device, the hub 9114 may retrieve VR assets, video, audio, or other media or data related to sensory information via a network node, which the hub 9114 then provides to the UE either directly, after performing local processing, and/or after adding additional local content. In still another example, the hub 9114 acts as a proxy server or orchestrator for the UEs, in particular if one or more of the UEs are low energy IoT devices.

The hub 9114 may have a constant/persistent or intermittent connection to the network node 9110b. The hub 9114 may also allow for a different communication scheme and/or schedule between the hub 9114 and UEs (e.g., UE 9112c and/or 9112d), and between the hub 9114 and the core network 9106. In other examples, the hub 9114 is connected to the core network 9106 and/or one or more UEs via a wired connection. Moreover, the hub 9114 may be configured to connect to an M2M service provider over the access network 9104 and/or to another UE over a direct connection. In some scenarios, UEs may establish a wireless connection with the network nodes 9110 while still connected via the hub 9114 via a wired or wireless connection. In some embodiments, the hub 9114 may be a dedicated hub—that is, a hub whose primary function is to route communications to/from the UEs from/to the network node 9110b. In other embodiments, the hub 9114 may be a non-dedicated hub—that is, a device which is capable of operating to route communications between the UEs and network node 9110b, but which is additionally capable of operating as a communication start and/or end point for certain data channels.

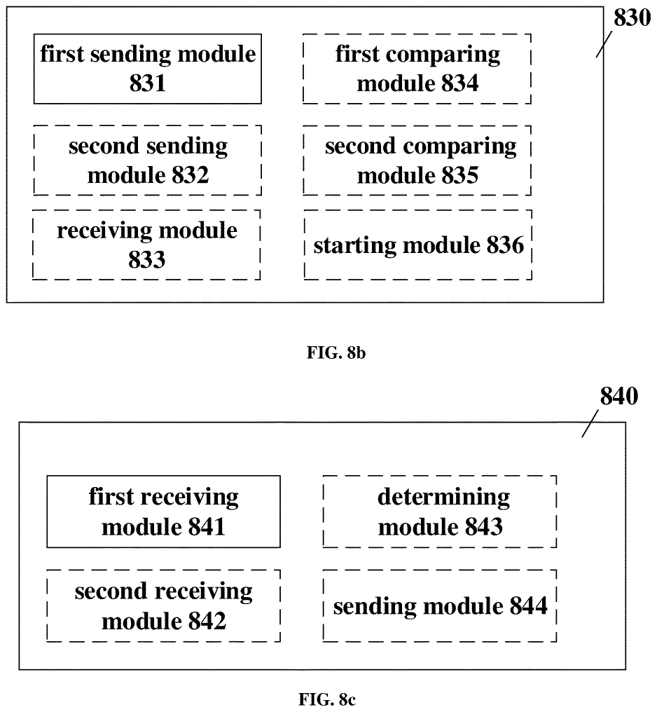

FIG. 10 shows a UE 10200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 10200 includes processing circuitry 10202 that is operatively coupled via a bus 10204 to an input/output interface 10206, a power source 10208, a memory 10210, a communication interface 10212, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 10202 is configured to process instructions and data and may be configured to implement any sequential state machine operative to execute instructions stored as machine-readable computer programs in the memory 10210. The processing circuitry 10202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 10202 may include multiple central processing units (CPUs).

In the example, the input/output interface 10206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 10200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 10208 is structured as a battery or battery pack. Other types of power sources, such as an external power source (e.g., an electricity outlet), photovoltaic device, or power cell, may be used. The power source 10208 may further include power circuitry for delivering power from the power source 10208 itself, and/or an external power source, to the various parts of the UE 10200 via input circuitry or an interface such as an electrical power cable. Delivering power may be, for example, for charging of the power source 10208. Power circuitry may perform any formatting, converting, or other modification to the power from the power source 10208 to make the power suitable for the respective components of the UE 10200 to which power is supplied.

The memory 10210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 10210 includes one or more application programs 10214, such as an operating system, web browser application, a widget, gadget engine, or other application, and corresponding data 10216. The memory 10210 may store, for use by the UE 10200, any of a variety of various operating systems or combinations of operating systems.

The memory 10210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 10210 may allow the UE 10200 to access instructions, application programs and the like, stored on transitory or non-transitory memory media, to off-load data, or to upload data. An article of manufacture, such as one utilizing a communication system may be tangibly embodied as or in the memory 10210, which may be or comprise a device-readable storage medium.

The processing circuitry 10202 may be configured to communicate with an access network or other network using the communication interface 10212. The communication interface 10212 may comprise one or more communication subsystems and may include or be communicatively coupled to an antenna 10222. The communication interface 10212 may include one or more transceivers used to communicate, such as by communicating with one or more remote transceivers of another device capable of wireless communication (e.g., another UE or a network node in an access network). Each transceiver may include a transmitter 10218 and/or a receiver 10220 appropriate to provide network communications (e.g., optical, electrical, frequency allocations, and so forth). Moreover, the transmitter 10218 and receiver 10220 may be coupled to one or more antennas (e.g., antenna 10222) and may share circuit components, software or firmware, or alternatively be implemented separately.

In the illustrated embodiment, communication functions of the communication interface 10212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 10212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 10200 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

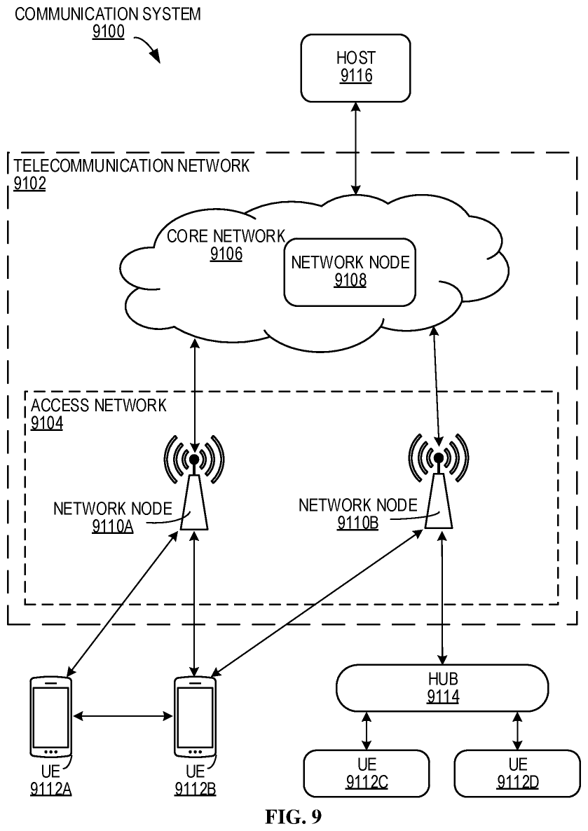

FIG. 11 shows a network node 11300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 11300 includes a processing circuitry 11302, a memory 11304, a communication interface 11306, and a power source 11308. The network node 11300 may be composed of multiple physically separate components (e.g., a NodeB component and a RNC component, or a BTS component and a BSC component, etc.), which may each have their own respective components. In certain scenarios in which the network node 11300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 11300 may be configured to support multiple radio access technologies (RATs). In such embodiments, some components may be duplicated (e.g., separate memory 11304 for different RATs) and some components may be reused (e.g., a same antenna 11310 may be shared by different RATs). The network node 11300 may also include multiple sets of the various illustrated components for different wireless technologies integrated into network node 11300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 11300.

The processing circuitry 11302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 11300 components, such as the memory 11304, to provide network node 11300 functionality.

In some embodiments, the processing circuitry 11302 includes a system on a chip (SOC). In some embodiments, the processing circuitry 11302 includes one or more of radio frequency (RF) transceiver circuitry 11312 and baseband processing circuitry 11314. In some embodiments, the radio frequency (RF) transceiver circuitry 11312 and the baseband processing circuitry 11314 may be on separate chips (or sets of chips), boards, or units, such as radio units and digital units. In alternative embodiments, part or all of RF transceiver circuitry 11312 and baseband processing circuitry 11314 may be on the same chip or set of chips, boards, or units.

The memory 11304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 11302. The memory 11304 may store any suitable instructions, data, or information, including a computer program, software, an application including one or more of logic, rules, code, tables, and/or other instructions capable of being executed by the processing circuitry 11302 and utilized by the network node 11300. The memory 11304 may be used to store any calculations made by the processing circuitry 11302 and/or any data received via the communication interface 11306. In some embodiments, the processing circuitry 11302 and memory 11304 is integrated.

The communication interface 11306 is used in wired or wireless communication of signaling and/or data between a network node, access network, and/or UE. As illustrated, the communication interface 11306 comprises port(s)/terminal(s) 11316 to send and receive data, for example to and from a network over a wired connection. The communication interface 11306 also includes radio front-end circuitry 11318 that may be coupled to, or in certain embodiments a part of, the antenna 11310. Radio front-end circuitry 11318 comprises filters 11320 and amplifiers 11322. The radio front-end circuitry 11318 may be connected to an antenna 11310 and processing circuitry 11302. The radio front-end circuitry may be configured to condition signals communicated between antenna 11310 and processing circuitry 11302. The radio front-end circuitry 11318 may receive digital data that is to be sent out to other network nodes or UEs via a wireless connection. The radio front-end circuitry 11318 may convert the digital data into a radio signal having the appropriate channel and bandwidth parameters using a combination of filters 11320 and/or amplifiers 11322. The radio signal may then be transmitted via the antenna 11310. Similarly, when receiving data, the antenna 11310 may collect radio signals which are then converted into digital data by the radio front-end circuitry 11318. The digital data may be passed to the processing circuitry 11302. In other embodiments, the communication interface may comprise different components and/or different combinations of components.

In certain alternative embodiments, the network node 11300 does not include separate radio front-end circuitry 11318, instead, the processing circuitry 11302 includes radio front-end circuitry and is connected to the antenna 11310. Similarly, in some embodiments, all or some of the RF transceiver circuitry 11312 is part of the communication interface 11306. In still other embodiments, the communication interface 11306 includes one or more ports or terminals 11316, the radio front-end circuitry 11318, and the RF transceiver circuitry 11312, as part of a radio unit (not shown), and the communication interface 11306 communicates with the baseband processing circuitry 11314, which is part of a digital unit (not shown).

The antenna 11310 may include one or more antennas, or antenna arrays, configured to send and/or receive wireless signals. The antenna 11310 may be coupled to the radio front-end circuitry 11318 and may be any type of antenna capable of transmitting and receiving data and/or signals wirelessly. In certain embodiments, the antenna 11310 is separate from the network node 11300 and connectable to the network node 11300 through an interface or port.

The antenna 11310, communication interface 11306, and/or the processing circuitry 11302 may be configured to perform any receiving operations and/or certain obtaining operations described herein as being performed by the network node. Any information, data and/or signals may be received from a UE, another network node and/or any other network equipment. Similarly, the antenna 11310, the communication interface 11306, and/or the processing circuitry 11302 may be configured to perform any transmitting operations described herein as being performed by the network node. Any information, data and/or signals may be transmitted to a UE, another network node and/or any other network equipment.

The power source 11308 provides power to the various components of network node 11300 in a form suitable for the respective components (e.g., at a voltage and current level needed for each respective component). The power source 11308 may further comprise, or be coupled to, power management circuitry to supply the components of the network node 11300 with power for performing the functionality described herein. For example, the network node 11300 may be connectable to an external power source (e.g., the power grid, an electricity outlet) via an input circuitry or interface such as an electrical cable, whereby the external power source supplies power to power circuitry of the power source 11308. As a further example, the power source 11308 may comprise a source of power in the form of a battery or battery pack which is connected to, or integrated in, power circuitry. The battery may provide backup power should the external power source fail.

Embodiments of the network node 11300 may include additional components beyond those shown in FIG. 11 for providing certain aspects of the network node's functionality, including any of the functionality described herein and/or any functionality necessary to support the subject matter described herein. For example, the network node 11300 may include user interface equipment to allow input of information into the network node 11300 and to allow output of information from the network node 11300. This may allow a user to perform diagnostic, maintenance, repair, and other administrative functions for the network node 11300.

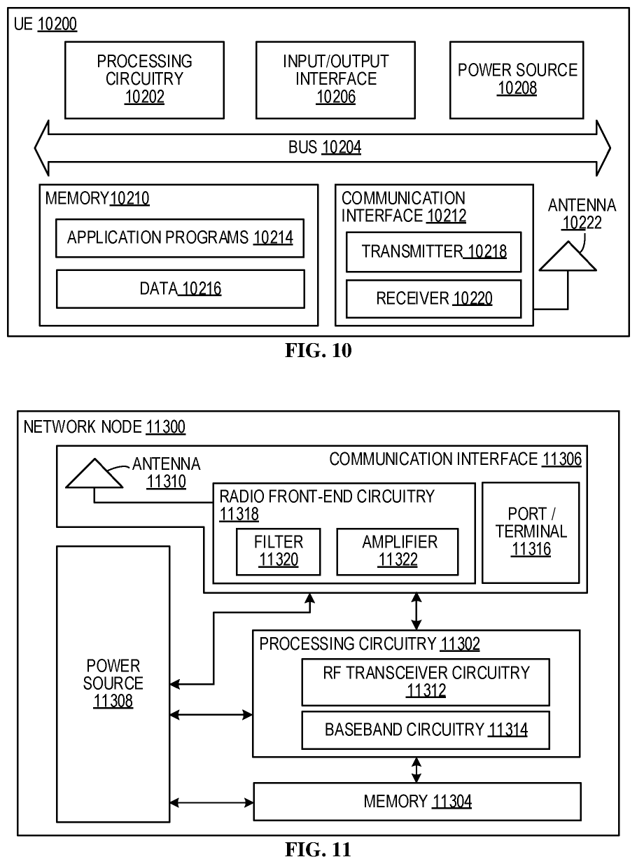

FIG. 12 is a block diagram of a host 12400, which may be an embodiment of the host 9116 of FIG. 9, in accordance with various aspects described herein. As used herein, the host 12400 may be or comprise various combinations hardware and/or software, including a standalone server, a blade server, a cloud-implemented server, a distributed server, a virtual machine, container, or processing resources in a server farm. The host 12400 may provide one or more services to one or more UEs.

The host 12400 includes processing circuitry 12402 that is operatively coupled via a bus 12404 to an input/output interface 12406, a network interface 12408, a power source 12410, and a memory 12412. Other components may be included in other embodiments. Features of these components may be substantially similar to those described with respect to the terminal devices, such that the descriptions thereof are generally applicable to the corresponding components of host 12400.

The memory 12412 may include one or more computer programs including one or more host application programs 12414 and data 12416, which may include user data, e.g., data generated by a UE for the host 12400 or data generated by the host 12400 for a UE. Embodiments of the host 12400 may utilize only a subset or all of the components shown. The host application programs 12414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 12414 may also provide for user authentication and licensing checks and may periodically report health, routes, and content availability to a central node, such as a device in or on the edge of a core network. Accordingly, the host 12400 may select and/or indicate a different host for over-the-top services for a UE. The host application programs 12414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

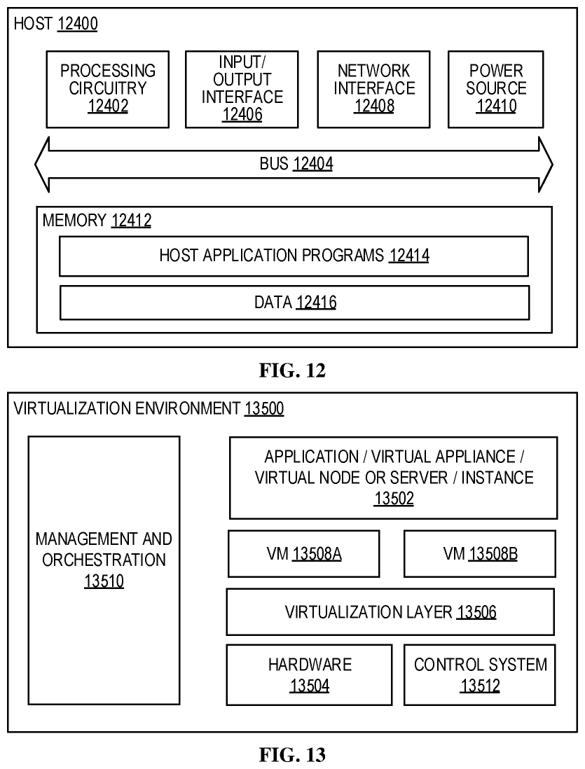

FIG. 13 is a block diagram illustrating a virtualization environment 13500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 13500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 13500 includes components defined by the O-RAN Alliance, such as an O-Cloud environment orchestrated by a Service Management and Orchestration Framework via an O-2 interface.

Applications 13502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 13504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 13506 (also referred to as hypervisors or virtual machine monitors (VMMs)), provide VMs 13508A and 13508B (one or more of which may be generally referred to as VMs 13508), and/or perform any of the functions, features and/or benefits described in relation with some embodiments described herein. The virtualization layer 13506 may present a virtual operating platform that appears like networking hardware to the VMs 13508.

The VMs 13508 comprise virtual processing, virtual memory, virtual networking or interface and virtual storage, and may be run by a corresponding virtualization layer 13506. Different embodiments of the instance of a virtual appliance 13502 may be implemented on one or more of VMs 13508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 13508 may be a software implementation of a physical machine that runs programs as if they were executing on a physical, non-virtualized machine. Each of the VMs 13508, and that part of hardware 13504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 13508 on top of the hardware 13504 and corresponds to the application 13502.

Hardware 13504 may be implemented in a standalone network node with generic or specific components. Hardware 13504 may implement some functions via virtualization. Alternatively, hardware 13504 may be part of a larger cluster of hardware (e.g. such as in a data center or CPE) where many hardware nodes work together and are managed via management and orchestration 13510, which, among others, oversees lifecycle management of applications 13502. In some embodiments, hardware 13504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 13512 which may alternatively be used for communication between hardware nodes and radio units.

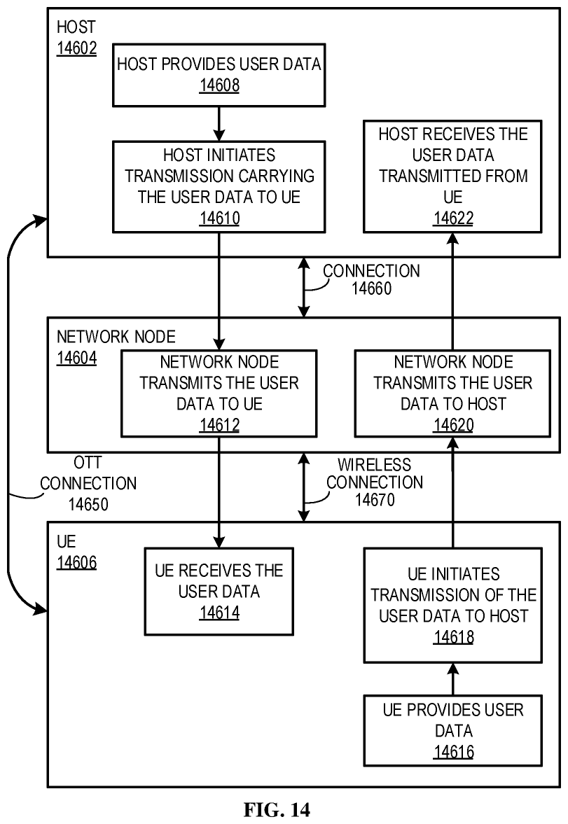

FIG. 14 shows a communication diagram of a host 14602 communicating via a network node 14604 with a UE 14606 over a partially wireless connection in accordance with some embodiments. Example implementations, in accordance with various embodiments, of the UE (such as a UE 9112a of FIG. 9), network node (such as network node 9110a of FIG. 9), and host (such as host 9116 of FIG. 9 and/or host 12400 of FIG. 12) discussed in the preceding paragraphs will now be described with reference to FIG. 14.

Like host 12400, embodiments of host 14602 include hardware, such as a communication interface, processing circuitry, and memory. The host 14602 also includes software, which is stored in or accessible by the host 14602 and executable by the processing circuitry. The software includes a host application that may be operable to provide a service to a remote user, such as the UE 14606 connecting via an over-the-top (OTT) connection 14650 extending between the UE 14606 and host 14602. In providing the service to the remote user, a host application may provide user data which is transmitted using the OTT connection 14650.

The network node 14604 includes hardware enabling it to communicate with the host 14602 and UE 14606. The connection 14660 may be direct or pass through a core network (like core network 9106 of FIG. 9) and/or one or more other intermediate networks, such as one or more public, private, or hosted networks. For example, an intermediate network may be a backbone network or the Internet.

The UE 14606 includes hardware and software, which is stored in or accessible by UE 14606 and executable by the UE's processing circuitry. The software includes a client application, such as a web browser or operator-specific “app” that may be operable to provide a service to a human or non-human user via UE 14606 with the support of the host 14602. In the host 14602, an executing host application may communicate with the executing client application via the OTT connection 14650 terminating at the UE 14606 and host 14602. In providing the service to the user, the UE's client application may receive request data from the host's host application and provide user data in response to the request data. The OTT connection 14650 may transfer both the request data and the user data. The UE's client application may interact with the user to generate the user data that it provides to the host application through the OTT connection 14650.

The OTT connection 14650 may extend via a connection 14660 between the host 14602 and the network node 14604 and via a wireless connection 14670 between the network node 14604 and the UE 14606 to provide the connection between the host 14602 and the UE 14606. The connection 14660 and wireless connection 14670, over which the OTT connection 14650 may be provided, have been drawn abstractly to illustrate the communication between the host 14602 and the UE 14606 via the network node 14604, without explicit reference to any intermediary devices and the precise routing of messages via these devices.

As an example of transmitting data via the OTT connection 14650, in step 14608, the host 14602 provides user data, which may be performed by executing a host application. In some embodiments, the user data is associated with a particular human user interacting with the UE 14606. In other embodiments, the user data is associated with a UE 14606 that shares data with the host 14602 without explicit human interaction. In step 14610, the host 14602 initiates a transmission carrying the user data towards the UE 14606. The host 14602 may initiate the transmission responsive to a request transmitted by the UE 14606. The request may be caused by human interaction with the UE 14606 or by operation of the client application executing on the UE 14606. The transmission may pass via the network node 14604, in accordance with the teachings of the embodiments described throughout this disclosure. Accordingly, in step 14612, the network node 14604 transmits to the UE 14606 the user data that was carried in the transmission that the host 14602 initiated, in accordance with the teachings of the embodiments described throughout this disclosure. In step 14614, the UE 14606 receives the user data carried in the transmission, which may be performed by a client application executed on the UE 14606 associated with the host application executed by the host 14602.

In some examples, the UE 14606 executes a client application which provides user data to the host 14602. The user data may be provided in reaction or response to the data received from the host 14602. Accordingly, in step 14616, the UE 14606 may provide user data, which may be performed by executing the client application. In providing the user data, the client application may further consider user input received from the user via an input/output interface of the UE 14606. Regardless of the specific manner in which the user data was provided, the UE 14606 initiates, in step 14618, transmission of the user data towards the host 14602 via the network node 14604. In step 14620, in accordance with the teachings of the embodiments described throughout this disclosure, the network node 14604 receives user data from the UE 14606 and initiates transmission of the received user data towards the host 14602. In step 14622, the host 14602 receives the user data carried in the transmission initiated by the UE 14606.

One or more of the various embodiments improve the performance of OTT services provided to the UE 14606 using the OTT connection 14650, in which the wireless connection 14670 forms the last segment. More precisely, in some embodiments herein, it enables a terminal device to report the power headroom information for a target waveform. In some embodiments herein, it enables the terminal device to select a waveform from two waveforms, for which the UE reports its PHR first or only. In some embodiments herein, it enables the terminal device to know when to start or restart phr-PeriodicTimer and/or phr-ProhibitTimer. In some embodiments herein, the legacy PHR MAC CE for a waveform can be reused as much as possible. In some embodiments herein, a legacy field can be repurposed to indicate the power information related to the two waveforms. In some embodiments herein, the power difference quantization method is used to report power information for a waveform, which can enable fewer bits to be occupied. In some embodiments herein, it enables the terminal device to report power headroom information of two waveforms in a PHR MAC CE. In some embodiments herein, it enables the terminal device to report power headroom information of two waveforms in separate PHR MAC CEs.

In an example scenario, factory status information may be collected and analyzed by the host 14602. As another example, the host 14602 may process audio and video data which may have been retrieved from a UE for use in creating maps. As another example, the host 14602 may collect and analyze real-time data to assist in controlling vehicle congestion (e.g., controlling traffic lights). As another example, the host 14602 may store surveillance video uploaded by a UE. As another example, the host 14602 may store or control access to media content such as video, audio, VR or AR which it can broadcast, multicast or unicast to UEs. As other examples, the host 14602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 14650 between the host 14602 and UE 14606, in response to variations in the measurement results. The measurement procedure and/or the network functionality for reconfiguring the OTT connection may be implemented in software and hardware of the host 14602 and/or UE 14606. In some embodiments, sensors (not shown) may be deployed in or in association with other devices through which the OTT connection 14650 passes; the sensors may participate in the measurement procedure by supplying values of the monitored quantities exemplified above, or supplying values of other physical quantities from which software may compute or estimate the monitored quantities. The reconfiguring of the OTT connection 14650 may include message format, retransmission settings, preferred routing etc.; the reconfiguring need not directly alter the operation of the network node 14604. Such procedures and functionalities may be known and practiced in the art. In certain embodiments, measurements may involve proprietary UE signaling that facilitates measurements of throughput, propagation times, latency and the like, by the host 14602. The measurements may be implemented in that software causes messages to be transmitted, in particular empty or ‘dummy’ messages, using the OTT connection 14650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.
Embodiment 1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations performed by the network node as described above to transmit the user data from the host to the UE or manage the transmission of the user data from the host to the UE.
Embodiment 2. The host of the previous embodiment, wherein:
the processing circuitry of the host is configured to execute a host application that provides the user data; and
the UE comprises processing circuitry configured to execute a client application associated with the host application to receive the transmission of user data from the host.
Embodiment 3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the operations performed by the network node as described above to transmit the user data from the host to the UE or manage the transmission of the user data from the host to the UE.
Embodiment 4. The method of the previous embodiment, further comprising, at the network node, transmitting the user data provided by the host for the UE.
Embodiment 5. The method of any of the previous 2 embodiments, wherein the user data is provided at the host by executing a host application that interacts with a client application executing on the UE, the client application being associated with the host application.
Embodiment 6. A communication system configured to provide an over-the-top (OTT) service, the communication system comprising:
a host comprising:
processing circuitry configured to provide user data for a user equipment (UE), the user
data being associated with the over-the-top service; and
a network interface configured to initiate transmission of the user data toward a cellular network node for transmission to the UE, the network node having a communication interface and processing circuitry, the processing circuitry of the network node configured to perform any of the operations performed by the network node as described above transmit the user data from the host to the UE or manage the transmission of the user data from the host to the UE.
Embodiment 7. The communication system of the previous embodiment, further comprising:
the network node; and/or
the user equipment.
Embodiment 8. The communication system of the previous 2 embodiments, wherein:
the processing circuitry of the host is configured to execute a host application, thereby providing the user data; and
the host application is configured to interact with a client application executing on the UE, the client application being associated with the host application.
Embodiment 9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations performed by the network node as described above to receive the user data from the UE for the host or manage the reception of the user data from the UE for the host.
Embodiment 10. The host of the previous 2 embodiments, wherein:
the processing circuitry of the host is configured to execute a host application, thereby providing the user data; and
the host application is configured to interact with a client application executing on the UE, the client application being associated with the host application.
Embodiment 11. The host of they of the previous 2 embodiments, wherein the initiating receipt of the user data comprises requesting the user data.
Embodiment 12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the operations performed by the network node as described above to receive the user data from the UE for the host or manage the reception of the user data from the UE for the host.
Embodiment 13. The method of the previous embodiment, further comprising at the network node, transmitting the received user data to the host.
Embodiment 14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform any of the operations performed by the UE as described above to receive the user data from the host.
Embodiment 15. The host of the previous embodiment, wherein the cellular network further includes a network node configured to communicate with the UE to transmit the user data to the UE from the host.
Embodiment 16. The host of the previous 2 embodiments, wherein:
the processing circuitry of the host is configured to execute a host application, thereby providing the user data; and
the host application is configured to interact with a client application executing on the UE, the client application being associated with the host application.
Embodiment 17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations performed by the UE as described above to receive the user data from the host.
Embodiment 18. The method of the previous embodiment, further comprising:
at the host, executing a host application associated with a client application executing on the UE to receive the user data from the UE.
Embodiment 19. The method of the previous embodiment, further comprising:
at the host, transmitting input data to the client application executing on the UE, the input data being provided by executing the host application,
wherein the user data is provided by the client application in response to the input data from the host application.
Embodiment 20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform any of the operations performed by the UE as described above to transmit the user data to the host.
Embodiment 21. The host of the previous embodiment, wherein the cellular network further includes a network node configured to communicate with the UE to transmit the user data from the UE to the host.
Embodiment 22. The host of the previous 2 embodiments, wherein:
the processing circuitry of the host is configured to execute a host application, thereby providing the user data; and
the host application is configured to interact with a client application executing on the UE, the client application being associated with the host application.
Embodiment 23. A method implemented by a host configured to operate in a communication system that further includes a network node and a user equipment (UE), the method comprising:
at the host, receiving user data transmitted to the host via the network node by the UE, wherein the UE performs any of the operations performed by the UE as described above to transmit the user data to the host.
Embodiment 24. The method of the previous embodiment, further comprising:
at the host, executing a host application associated with a client application executing on the UE to receive the user data from the UE.
Embodiment 25. The method of the previous embodiments, further comprising:
at the host, transmitting input data to the client application executing on the UE, the input data being provided by executing the host application,
wherein the user data is provided by the client application in response to the input data from the host application.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1.-15. (canceled)

16. A method performed by a terminal device, comprising:
sending a first power headroom report (PHR) to a network device, wherein:
the first PHR comprises the following: first power headroom information about a first waveform configured for the terminal device, and second power headroom information about a second waveform configured for the terminal device;
the first power headroom information comprises the following: information about first maximum output power of the first waveform, and first power headroom level for the first waveform;
the second power headroom information comprises information about second maximum output power of the second waveform;
the first waveform is currently used by the terminal device; and
the second waveform is a target waveform for a waveform switch by the terminal device.

17. The method according to claim 16, wherein the first PHR comprises second waveform indication information associated with the second power headroom information, wherein the second waveform indication information is indicated by one of the following:
a bit of a field in a PHR medium access control (MAC) control element (CE) in an octet comprising the second power headroom information, or
a bit of a field in a PHR MAC CE in an octet comprising the first power headroom information.

18. The method according to claim 17, wherein one or more of the following applies:
the second power headroom information is appended after the first power headroom information; and
the information about the second maximum output power of the second waveform is appended after one of the following:
the information about the first maximum output power of the first waveform, or
the information about the first power headroom level for the first waveform.

19. The method according to claim 16, wherein:
the first PHR comprises a Single Entry PHR medium access control (MAC) control element (CE); and
the first power headroom information and the second power headroom information are associated with a primary cell (PCell) for the terminal device.

20. The method according to claim 16, wherein:
the terminal device is configured for one or more of the following: dual connection (DC), and carrier aggregation (CA);
the first PHR comprises a Multiple Entry PHR medium access control (MAC) control element (CE); and
the first power headroom information and second power headroom information are associated with multiple serving cells for the terminal device.

21. The method according to claim 16, wherein one of the following applies:
the first waveform is cyclic prefix orthogonal frequency division multiplexing (CP-OFDM) and the second waveform is Discrete Fourier Transform spread (DFT-S) OFDM; or
the first waveform is DFT-S-OFDM and the second waveform is CP-OFDM.

22. The method according to claim 16, further comprising, after sending the first PHR, receiving from the network device signaling indicating a waveform switching.

23. A method performed by a network device, comprising:
receiving a first power headroom report (PHR) from a terminal device, wherein:
the first PHR comprises the following: first power headroom information about a first waveform configured for the terminal device, and second power headroom information about a second waveform configured for the terminal device;
the first power headroom information comprises the following: information about first maximum output power of the first waveform, and first power headroom level for the first waveform;
the second power headroom information comprises information about second maximum output power of the second waveform;
the first waveform is currently used by the terminal device; and
the second waveform is a target waveform for a waveform switch by the terminal device.

24. The method according to claim 23, wherein the first PHR comprises second waveform indication information associated with the second power headroom information, wherein the second waveform indication information is indicated by one of the following:
a bit of a field in a PHR medium access control (MAC) control element (CE) in an octet comprising the second power headroom information, or
a bit of a field in a PHR MAC CE in an octet comprising the first power headroom information.

25. The method according to claim 24, wherein one or more of the following applies:
the second power headroom information is appended after the first power headroom information; and
the information about the second maximum output power of the second waveform is appended after one of the following:
the information about the first maximum output power of the first waveform, or
the information about the first power headroom level for the first waveform.

26. The method according to claim 23, wherein one of the following applies:
the first waveform is cyclic prefix orthogonal frequency division multiplexing (CP-OFDM) and the second waveform is Discrete Fourier Transform spread (DFT-S) OFDM; or
the first waveform is DFT-S-OFDM and the second waveform is CP-OFDM.

27. A terminal device comprising:
a processor; and
a memory operatively coupled to the processor and having stored therein instructions that, when executed by the processor, configure the terminal device to:
send a first power headroom report (PHR) to a network device, wherein:
the first PHR comprises the following: first power headroom information about a first waveform configured for the terminal device, and second power headroom information about a second waveform configured for the terminal device;
the first power headroom information comprises the following: information about first maximum output power of the first waveform, and first power headroom level for the first waveform;
the second power headroom information comprises information about second maximum output power of the second waveform;
the first waveform is currently used by the terminal device; and
the second waveform is a target waveform for a waveform switch by the terminal device.

28. The terminal device according to claim 27, wherein the first PHR comprises second waveform indication information associated with the second power headroom information, wherein the second waveform indication information is indicated by one of the following:
a bit of a field in a PHR medium access control (MAC) control element (CE) in an octet comprising the second power headroom information, or
a bit of a field in a PHR MAC CE in an octet comprising the first power headroom information.

29. The terminal device according to claim 28, wherein one or more of the following applies:
the second power headroom information is appended after the first power headroom information; and
the information about the second maximum output power of the second waveform is appended after one of the following:
the information about the first maximum output power of the first waveform, or
the information about the first power headroom level for the first waveform.

30. The terminal device according to claim 27, wherein:
the first PHR comprises a Single Entry PHR medium access control (MAC) control element (CE); and
the first power headroom information and the second power headroom information are associated with a primary cell (PCell) for the terminal device.

31. The terminal device according to claim 27, wherein:
the terminal device is configured for one or more of the following: dual connection (DC), and carrier aggregation (CA);
the first PHR comprises a Multiple Entry PHR medium access control (MAC) control element (CE); and
the first power headroom information and second power headroom information are associated with multiple serving cells for the terminal device.

32. The terminal device according to claim 27, wherein one of the following applies:
the first waveform is cyclic prefix orthogonal frequency division multiplexing (CP-OFDM) and the second waveform is Discrete Fourier Transform spread (DFT-S) OFDM; or
the first waveform is DFT-S-OFDM and the second waveform is CP-OFDM.

33. The terminal device according to claim 27, wherein execution of the instructions by the processor further configures the terminal device to, after sending the first PHR, receive from the network device signaling indicating a waveform switching.

34. A network device, comprising:
a processor; and
a memory operatively coupled to the processor and having stored therein instructions that, when executed by the processor, configure the network device to:
receive a first power headroom report (PHR) from a terminal device, wherein:
the first PHR comprises the following: first power headroom information about a first waveform configured for the terminal device, and second power headroom information about a second waveform configured for the terminal device;
the first power headroom information comprises the following: information about first maximum output power of the first waveform, and first power headroom level for the first waveform;
the second power headroom information comprises information about second maximum output power of the second waveform;
the first waveform is currently used by the terminal device; and
the second waveform is a target waveform for a waveform switch by the terminal device.

35. The network device according to claim 34, wherein the first PHR comprises second waveform indication information associated with the second power headroom information, wherein the second waveform indication information is indicated by one of the following:
a bit of a field in a PHR medium access control (MAC) control element (CE) in an octet comprising the second power headroom information, or
a bit of a field in a PHR MAC CE in an octet comprising the first power headroom information.

36. The network device according to claim 35, wherein one or more of the following applies:
the second power headroom information is appended after the first power headroom information; and
the information about the second maximum output power of the second waveform is appended after one of the following:
the information about the first maximum output power of the first waveform, or
the information about the first power headroom level for the first waveform.

37. The network device according to claim 34, wherein one of the following applies:
the first waveform is cyclic prefix orthogonal frequency division multiplexing (CP-OFDM) and the second waveform is Discrete Fourier Transform spread (DFT-S) OFDM; or
the first waveform is DFT-S-OFDM and the second waveform is CP-OFDM.
